(19) United States
(12) Patent Application Publication
(10) Pub. No.: US 2024/0188042 A1
(43) Pub. Date: Jun. 6, 2024

(54) PAGING EARLY INDICATION ENHANCEMENTS

(71) Applicant: Fraunhofer-Gesellschaft zur Förderung der angewandten Forschung e.V., München (DE)

(72) Inventors: Dariush MOHAMMAD SOLEYMANI, Erlangen (DE); Julian POPP, Erlangen (DE); Gustavo Wagner OLIVEIRA DA COSTA, Erlangen (DE); Clemens KORN, Erlangen (DE); Baris GÖKTEPE, Berlin (DE); Thomas FEHRENBACH, Berlin (DE); Thomas WIRTH, Berlin (DE); Cornelius HELLGE, Berlin (DE); Thomas SCHIERL, Berlin (DE)

(21) Appl. No.: 18/538,853

(22) Filed: Dec. 13, 2023

Related U.S. Application Data
(63) Continuation of application No. PCT/EP2022/065223, filed on Jun. 3, 2022.

(30) Foreign Application Priority Data
Jun. 17, 2021 (EP) 21180164.2

(51) Int. Cl. H04W 68/02; H04W 68/00

(52) U.S. Cl. CPC H04W 68/025; H04W 68/005

(57) ABSTRACT

In a wireless communication network a user device, UE, and a base station, gNB, are provided. The UE monitors one or more paging occasions, POs, for a paging signal directed to the UE by the base station network and receives, ahead of an upcoming PO, a paging early indication, PEI, the PEI indicating whether the UE is to expect a paging signal in the upcoming PO. Paging early indication, PEI, enhancements, for example for improving a power saving behavior of a user device, are described.

### CROSS-REFERENCES TO RELATED APPLICATIONS

This application is a continuation of copending International Application No. PCT/EP2022/065223, filed Jun. 3, 2022, which is incorporated herein by reference in its entirety, and additionally claims priority from European Application No. EP 21 180 164.2, filed Jun. 17, 2021, which is incorporated herein by reference in its entirety.

The present invention relates to the field of wireless communication systems or networks, more specifically to the field of paging user devices of the wireless communication network. Embodiments concern paging early indication, PEI, enhancements, for example for improving a power saving behavior of a user device.

### BACKGROUND OF THE INVENTION

FIGS. 1A-1B are schematic representations of an example of a terrestrial wireless network 100 including, as is shown in FIG. 1A, the core network 102 and one or more radio access networks RAN₁, RAN₂, . . . RAN_{N}. FIG. 1B is a schematic representation of an example of a radio access network RANₙ that may include one or more base stations gNB₁ to gNB₅, each serving a specific area surrounding the base station schematically represented by respective cells 106₁ to 106₅. The base stations are provided to serve users within a cell. The one or more base stations may serve users in licensed and/or unlicensed bands. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT devices which connect to a base station or to a user. The mobile or stationary devices may include physical devices, ground based vehicles, such as robots or cars, aerial vehicles, such as manned or unmanned aerial vehicles, UAVs, the latter also referred to as drones, buildings and other items or devices having embedded therein electronics, software, sensors, actuators, or the like as well as network connectivity that enables these devices to collect and exchange data across an existing network infrastructure. FIG. 1B shows an exemplary view of five cells, however, the RANₙ may include more or less such cells, and RANₙ may also include only one base station. FIG. 1B shows two users UE₁ and UE₂, also referred to as user device or user equipment, that are in cell 106₂ and that are served by base station gNB₂. Another user UE₃ is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. This may be realized on licensed bands or on unlicensed bands. Further, FIG. 1B shows two further devices 110₁ and 110₂ in cell 106₄, like IoT devices, which may be stationary or mobile devices. The device 110₁ accesses the wireless communication system via the base station gNB₄ to receive and transmit data as schematically represented by arrow 112₁. The device 110₂ accesses the wireless communication system via the user UE₃ as is schematically represented by arrow 112₂. The respective base station gNB₁ to gNB₅ may be connected to the core network 102, e.g. via the S1 interface, via respective backhaul links 114₁ to 114₅, which are schematically represented in FIG. 1B by the arrows pointing to “core”. The core network 102 may be connected to one or more external networks. The external network may be the Internet, or a private network, such as an Intranet or any other type of campus networks, e.g. a private WiFi communication system or a 4G or 5G mobile communication system. Further, some or all of the respective base station gNB₁ to gNB₅ may be connected, e.g. via the S1 or X2 interface or the XN interface in NR, with each other via respective backhaul links 116₁ to 116₅, which are schematically represented in FIG. 1B by the arrows pointing to “gNBs”. A sidelink channel allows direct communication between UEs, also referred to as device-to-device, D2D, communication. The sidelink interface in 3GPP is named PC5.

For data transmission a physical resource grid may be used. The physical resource grid may comprise a set of resource elements to which various physical channels and physical signals are mapped. For example, the physical channels may include the physical downlink, uplink and sidelink shared channels, PDSCH, PUSCH, PSSCH, carrying user specific data, also referred to as downlink, uplink and sidelink payload data, the physical broadcast channel, PBCH, carrying for example a master information block, MIB, and one or more system information blocks, SIBs, one or more sidelink information blocks, SLIBs, if supported, the physical downlink, uplink and sidelink control channels, PDCCH, PUCCH, PSSCH, carrying for example the downlink control information, DCI, the uplink control information, UCI, and the sidelink control information, SCI, and physical sidelink feedback channels, PSFCH, carrying PC5 feedback responses. The sidelink interface may support a 2-stage SCI which refers to a first control region containing some parts of the SCI, also referred to as the 1^{st} stage SCI, and optionally, a second control region which contains a second part of control information, also referred to as the 2^{nd} stage SCI.

For the uplink, the physical channels may further include the physical random-access channel, PRACH or RACH, used by UEs for accessing the network once a UE synchronized and obtained the MIB and SIB. The physical signals may comprise reference signals or symbols, RS, synchronization signals and the like. The resource grid may comprise a frame or radio frame having a certain duration in the time domain and having a given bandwidth in the frequency domain. The frame may have a certain number of subframes of a predefined length, e.g. 1 ms. Each subframe may include one or more slots of 12 or 14 OFDM symbols depending on the cyclic prefix, CP, length. A frame may also have a smaller number of OFDM symbols, e.g. when utilizing shortened transmission time intervals, sTTI, or a mini-slot/non-slot-based frame structure comprising just a few OFDM symbols.

The wireless communication system may be any single-tone or multicarrier system using frequency-division multiplexing, like the orthogonal frequency-division multiplexing, OFDM, system, the orthogonal frequency-division multiple access, OFDMA, system, or any other Inverse Fast Fourier Transform, IFFT, based signal with or without Cyclic Prefix, CP, e.g. Discrete Fourier Transform-spread-OFDM, DFT-s-OFDM. Other waveforms, like non-orthogonal waveforms for multiple access, e.g. filter-bank multicarrier, FBMC, generalized frequency division multiplexing, GFDM, or universal filtered multi carrier, UFMC, may be used. The wireless communication system may operate, e.g., in accordance with the LTE-Advanced pro standard, or the 5G or NR, New Radio, standard, or the NR-U, New Radio Unlicensed, standard.

The wireless network or communication system depicted in FIGS. 1A-1B may be a heterogeneous network having distinct overlaid networks, e.g., a network of macro cells with each macro cell including a macro base station, like base station gNB₁ to gNB₅, and a network of small cell base stations, not shown in FIGS. 1A-1B, like femto or pico base stations. In addition to the above described terrestrial wireless network also non-terrestrial wireless communication networks, NTN, exist including spaceborne transceivers, like satellites, and/or airborne transceivers, like unmanned aircraft systems. The non-terrestrial wireless communication network or system may operate in a similar way as the terrestrial system described above with reference to FIGS. 1A-1B, for example in accordance with the LTE-Advanced Pro standard or the 5G or NR, new radio, standard.

In mobile communication networks, for example in a network like that described above with reference to FIGS. 1A-1B, like a LTE or 5G/NR network, there may be UEs that communicate directly with each other over one or more sidelink, SL, channels, e.g., using the PC5/PC3 interface or WiFi direct. UEs that communicate directly with each other over the sidelink may include vehicles communicating directly with other vehicles, V2V communication, vehicles communicating with other entities of the wireless communication network, V2X communication, for example roadside units, RSUs, roadside entities, like traffic lights, traffic signs, or pedestrians. An RSU may have a functionality of a BS or of a UE, depending on the specific network configuration. Other UEs may not be vehicular related UEs and may comprise any of the above-mentioned devices. Such devices may also communicate directly with each other, D2D communication, using the SL channels.

It is noted that the information in the above-section is only for enhancing the understanding of the background of the invention and, therefore, it may contain information that does not form conventional technology that is already known to a person of ordinary skill in the art.

Starting from the above, there may be a need for improvements or enhancements with regard to the paging of user devices of a wireless communication system or network.

### SUMMARY

An embodiment may have a user device, UE, for a wireless communication network, wherein the UE is to monitor one or more paging occasions, POs, for a paging signal directed to the UE by a base station of the wireless communication network, wherein the UE is to receive, ahead of an upcoming PO, a paging early indication, PEI, the PEI indicating whether the UE is to expect a paging signal in the upcoming PO, and wherein, in case the PEI indicates that the UE is to expect a paging signal in the upcoming PO and the UE does not detect the paging signal in the upcoming PO, the UE is to process one or more POs following the upcoming PO.

Another embodiment may have a user device, UE, for a wireless communication network, wherein the UE is to monitor one or more paging occasions, POs, for a paging signal directed to the UE by a base station of the wireless communication network, wherein the UE is to receive, ahead of an upcoming PO, a paging early indication, PEI, the PEI indicating whether the UE is to expect a paging signal in the upcoming PO, and wherein, in case a time gap between the PEI and the PO is less than a certain duration, the UE is to
skip the upcoming PO, or
skip the upcoming PO and process a PO following the upcoming PO.

Another embodiment may have a base station for a wireless communication network, the wireless communication network comprising one or more user devices, UEs, the UE to monitor one or more paging occasions, POs, for a paging signal directed to the UE by the base station, and wherein the UE requires a certain duration to be set up for processing an upcoming PO, wherein the base station is to send, ahead of the upcoming PO, a paging early indication, PEI, the PEI indicating whether the UE is to expect a paging signal in the upcoming PO, and wherein the base station is to send the PEI such that the PEI is received at the UE at least at the certain duration of the upcoming PEI.

Another embodiment may have a user device, UE, for a wireless communication network, wherein the UE is to monitor one or more paging occasions, POs, for a paging signal directed to the UE by a base station of the wireless communication network, wherein the UE is configured or preconfigured with a plurality of PO configurations, the plurality of PO configurations comprising at least a first PO configuration and a second PO configuration, and a first density of POs defined by the first PO configuration being lower than a second density of POs defined by the second PO configuration, and wherein the UE is to switch between the first and second PO configurations responsive to one or more certain events.

Another embodiment may have a base station for a wireless communication network, the wireless communication network comprising one or more user devices, UEs, the UE to monitor one or more paging occasions, POs, for a paging signal directed to the UE by the base station, wherein the base station is to configure the UE with a plurality of PO configurations, the plurality of PO configurations comprising at least a first PO configuration and a second PO configuration, and a first density of POs defined by the first PO configuration being lower than a second density of POs defined by the second PO configuration, and wherein the base station is to receive from the UE a signaling indicating a switch between the first and second PO configurations at then UE.

Another embodiment may have a user device, UE, for a wireless communication network, wherein the UE is to monitor one or more paging occasions, POs, for a paging signal directed to the UE by a base station of the wireless communication network, wherein the UE comprises a list of cells of the wireless communication network supporting a paging early indication, PEI, the PEI indicating whether the UE is to expect a paging signal in an upcoming PO, and wherein the UE is
to determine a current cell on which the UE currently camps,
to expect receiving a PEI ahead of an upcoming PO, in case the current cell is in the list of cells, and
not to expect receiving a PEI, in case the current cell is not in the list of cells.

Another embodiment may have a user device, UE, for a wireless communication network, wherein the UE is to monitor one or more paging occasions, POs, for a paging signal directed to the UE by a base station of the wireless communication network, wherein the UE is to receive, ahead of an upcoming PO, a paging early indication, PEI, the PEI indicating whether the UE is to expect a paging signal in the upcoming PO, wherein the UE is to operate in accordance with a first behavior or a second behavior, wherein in accordance with the first behavior the UE is to monitor one or more POs regardless if the PEI is received or not, and in accordance with the second behavior, the UE is to monitor one or more POs if the PEI indicates that the UE is to expect a paging signal in the upcoming PO, and wherein, when operating in accordance with the second behavior, the UE is to switch to the first behavior responsive to a certain event.

Another embodiment may have a wireless communication system, comprising one or more user devices, UEs, according to the invention.

Another embodiment may have a base station for a wireless communication network, the wireless communication network comprising a plurality of user devices, UEs, the UEs to monitor one or more paging occasions, POs, for a paging signal directed to the UEs by the base station, and wherein the plurality of UEs comprises at least a first UE and a second UE, the first UE to monitor a first PO at a first time, and the second UE to monitor a second PO at a second time, the second time being later than the first time, wherein the base station is to send, ahead of the first PO, a paging early indication, PEI, the PEI indicating whether the first UE is to expect a paging signal in the first PO and whether the second UE is to expect a paging signal in the second PO.

Another embodiment may have a user device, UE, for a wireless communication network, wherein the UE is to monitor one or more paging occasions, POs, for a paging signal directed to the UE by a base station of the wireless communication network, wherein the UE is to receive, ahead of an upcoming PO, a paging early indication, PEI, the PEI indicating whether the UE is to expect a paging signal in the upcoming PO, and wherein the PEI further indicates whether a further first UE is to expect a paging signal in a further PO, the further PO being at a time different from the time of the upcoming PO for the UE.

Another embodiment may have a base station for a wireless communication network, the wireless communication network comprising one or more user devices, UEs, the UE to monitor one or more paging occasions, POs, for a paging signal directed to the UE by the base station, and wherein the UE requires a certain duration to be set up for processing an upcoming PO, wherein the base station is to send, ahead of the upcoming PO,
a paging early indication, PEI, the PEI indicating whether the UE is to expect a paging signal in the upcoming PO, and
additional information for reducing the certain duration.

Another embodiment may have a user device, UE, for a wireless communication network, wherein the UE is to monitor one or more paging occasions, POs, for a paging signal directed to the UE by a base station of the wireless communication network, the UE requiring a certain duration to be set up for processing an upcoming PO, wherein the UE is to receive, ahead of an upcoming PO, a paging early indication, PEI, the PEI indicating whether the UE is to expect a paging signal in the upcoming PO, and wherein the base station is to receive, ahead of the upcoming PO, additional information for reducing the certain duration.

Another embodiment may have a wireless communication system, comprising one or more base stations according to the invention and/or one or more user devices, UEs, according to the invention.

Another embodiment may have a method for operating a wireless communication network, the method comprising: monitoring, by a user device, one or more paging occasions, POs, for a paging signal directed to the UE by a base station of the wireless communication network, receiving, by the UE, ahead of an upcoming PO, a paging early indication, PEI, the PEI indicating whether the UE is to expect a paging signal in the upcoming PO, and to processing, by the UE, one or more POs following the upcoming PO, if the PEI indicates that the UE is to expect a paging signal in the upcoming PO and the UE does not detect the paging signal in the upcoming PO.

Another embodiment may have a method for operating a wireless communication network, the method comprising: monitoring, by a user device, one or more paging occasions, POs, for a paging signal directed to the UE by a base station of the wireless communication network, receiving, by the UE, ahead of an upcoming PO, a paging early indication, PEI, the PEI indicating whether the UE is to expect a paging signal in the upcoming PO, and if a time gap between the PEI and the PO is less than a certain duration,
skipping the upcoming PO, or
skipping the upcoming PO and processing a PO following the upcoming PO.

Another embodiment may have a method for operating a wireless communication network, the method comprising: monitoring, by a user device, one or more paging occasions, POs, for a paging signal directed to the UE by a base station of the wireless communication network, wherein the UE is configured or preconfigured with a plurality of PO configurations, the plurality of PO configurations comprising at least a first PO configuration and a second PO configuration, and a first density of POs defined by the first PO configuration being lower than a second density of POs defined by the second PO configuration, and switching, by the UE, between the first and second PO configurations responsive to one or more certain events.

Another embodiment may have a method for operating a wireless communication network, the method comprising: monitoring, by a user device, one or more paging occasions, POs, for a paging signal directed to the UE by a base station of the wireless communication network, wherein the UE comprises a list of cells of the wireless communication network supporting a paging early indication, PEI, the PEI indicating whether the UE is to expect a paging signal in an upcoming PO, determining, by the UE, a current cell on which the UE currently camps, expecting, by the UE, to receive a PEI ahead of an upcoming PO, in case the current cell is in the list of cells, and not expecting, by the UE, to receive a PEI, in case the current cell is not in the list of cells.

Another embodiment may have a method for operating a wireless communication network, the method comprising: monitoring, by a user device, one or more paging occasions, POs, for a paging signal directed to the UE by a base station of the wireless communication network, receiving, by the UE, ahead of an upcoming PO, a paging early indication, PEI, the PEI indicating whether the UE is to expect a paging signal in the upcoming PO, wherein the UE is to operate in accordance with a first behavior or a second behavior, wherein in accordance with the first behavior the UE is to monitor one or more POs regardless if the PEI is received or not, and in accordance with the second behavior, the UE is to monitor one or more POs if the PEI indicates that the UE is to expect a paging signal in the upcoming PO, and when operating in accordance with the second behavior, switching to the first behavior responsive to a certain event.

Another embodiment may have a method for operating a wireless communication network, the wireless communication network comprising a plurality of user devices, UEs, the UEs to monitor one or more paging occasions, POs, for a paging signal directed to the UEs by the base station, and wherein the plurality of UEs comprises at least a first UE and a second UE, the first UE to monitor a first PO at a first time, and the second UE to monitor a second PO at a second time, the second time being later than the first time, the method comprising: sending by the base station, ahead of the first PO, a paging early indication, PEI, the PEI indicating whether the first UE is to expect a paging signal in the first PO and whether the second UE is to expect a paging signal in the second PO.

Another embodiment may have a method for operating a wireless communication network, the wireless communication network comprising one or more user devices, UEs, the UE to monitor one or more paging occasions, POs, for a paging signal directed to the UE by the base station, and wherein the UE requires a certain duration to be set up for processing an upcoming PO, the method comprising: sending, by the base station, ahead of the upcoming PO,
a paging early indication, PEI, the PEI indicating whether the UE is to expect a paging signal in the upcoming PO, and
additional information for reducing the certain duration.

Another embodiment may have a non-transitory digital storage medium having a computer program stored thereon to perform the methods according to the invention when said computer program is run by a computer.

### BRIEF DESCRIPTION OF THE DRAWINGS

Embodiments of the present invention will be detailed subsequently referring to the appended drawings, in which:

FIGS. 1A-1B are schematic representations of an example of a terrestrial wireless network;

FIG. 2 illustrates the concept of employing a paging early indication, PEI;

FIG. 3 is a schematic representation of a wireless communication system including a transmitter, like a base station, and one or more receivers, like user devices, UEs, for implementing embodiments of the present invention;

FIG. 4 illustrates a gNB and a user device in accordance with embodiments of the a first aspect of the present invention;

FIG. 5 illustrates a gNB and a user device in accordance with embodiments of the a second aspect of the present invention;

FIG. 6 schematically illustrates, in a similar way as FIG. 2, a time gap between a PEI received at a UE from a gNB over a radio channel, and an upcoming paging occasion, PO;

FIG. 7 illustrates a gNB and a user device in accordance with embodiments of a third aspect of the present invention;

FIGS. 8A-8B illustrate an embodiment of the third aspect of the present invention illustrating a switching between a first PO configuration (FIG. 8A) and a second PO configuration (FIG. 8B);

FIG. 9 illustrates a gNB and a user device in accordance with embodiments of a fourth aspect of the present invention;

FIG. 10 illustrates a part of a wireless communication network implementing embodiments of the fourth aspect of the present invention;

FIG. 11 illustrates a gNB and a user device in accordance with embodiments of a fifth aspect of the present invention;

FIG. 12 illustrates a SIB device in accordance with embodiments of the fourth aspect of the present invention;

FIG. 13 illustrates a gNB and a UE in accordance with embodiments of a sixth aspect of the present invention;

FIGS. 14A-14C illustrate an example of three UEs experiencing a high SINR, a medium SINR and a low SINR, respectively, on the radio channel between the respective UE and a gNB, and receiving respective PEIs;

FIGS. 15A-15C illustrate the use of a common PEI in accordance with embodiments of the sixth aspect of the present invention;

FIG. 16 illustrates a gNB and a UE in accordance with embodiments of a seventh aspect of the present invention; and

FIG. 17 illustrates an example of a computer system on which units or modules as well as the steps of the methods described in accordance with the inventive approach may execute.

### DETAILED DESCRIPTION OF THE INVENTION

Embodiments of the present invention are now described in more detail with reference to the accompanying drawings, in which the same or similar elements have the same reference signs assigned.

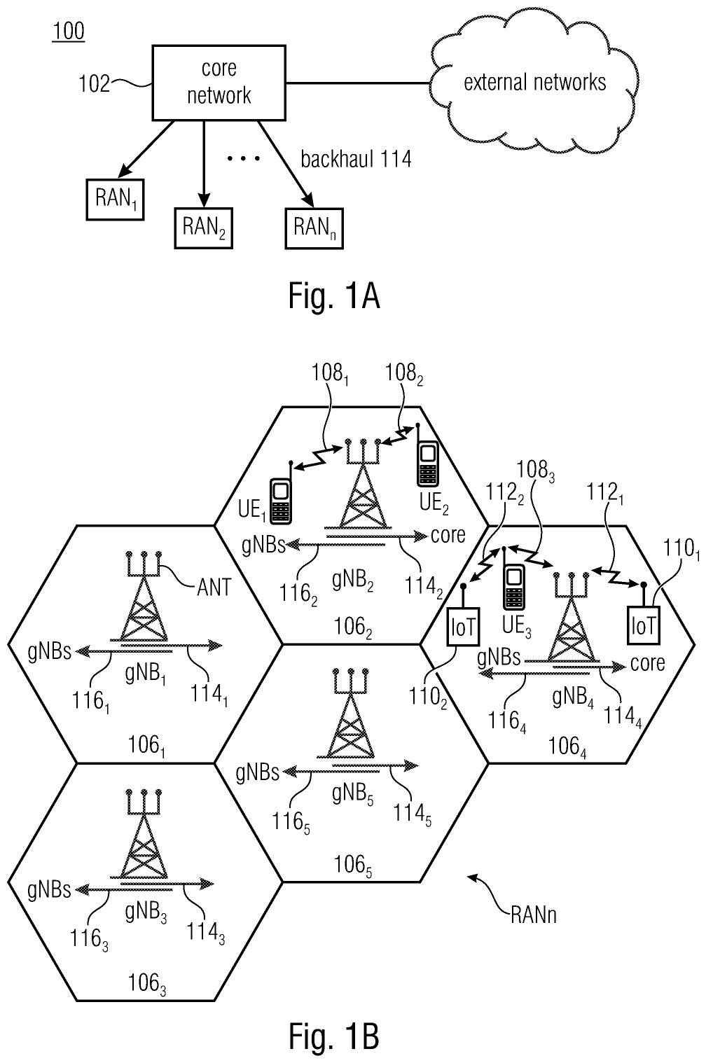

In a wireless communication system or network as described above, for example with reference to FIGS. 1A-1B, a user device, like a UE, may not have any ongoing data transmissions and it may enter an IDLE state or an INACTIVE state, for example to preserve its battery. In case new data arrives for the UE, the wireless communication network may probe the UE by sending a so-called paging message to which the UE responds. This is also referred to as the paging procedure, and the UE, when being in the IDLE or INACTIVE state keeps monitoring for the paging message at certain times, also referred to as paging occasions. At other times, the UE may implement the discontinuous reception, DRX, mode for saving power or battery lifetime by switching off the receiver. The paging procedure may be controlled by the core network, for example for UEs being in the IDLE state, while the paging procedure may also be controlled by the radio access network, RAN, for example for UEs being in an INACTIVE state. The times at which the UE switches on its receiver and checks for a paging message are referred to as paging occasion, PO. The network may use a paging frame which is a radio frame during which one or more POs for a number of UEs are transmitted. The PO is a specific time instant at which the network may transmit the paging message for respective UEs.

The above-described paging procedure may implement an additional technique to save even more power on the UE side, which is referred to as a paging early indication, PEI, which is a signal that is transmitted ahead of an upcoming paging occasion, PO, for signaling to the UE whether it is to expect a paging message in the upcoming PO or not.

The PEI is to be standardized for IDLE/INACTIVE UEs in Rel-17 of the 3GPP standardization, to reduce power consumption due to the paging UEs. The basic concept of the paging early indication is similar to the Rel-15/Rel-16 (g)WUS (wake-up signal or group wake-up signal). The group wake-up signal indicates to a group of UEs that a paging signal is going to be sent to that group. A UE being a member of the group is mandated to listen only to the upcoming paging occasion. In case there is no PEI received, the WUS indicates a different group so that UE may stay in a power-efficient mode without reading the paging information. The WUS is constructed in a way that it is easy to detect, even in case of poor channel quality. The PEI may contain information about a group ID and may also be used to decide whether an upcoming paging occasion holds information relevant for a specific UE or not. Further, the PEI-based approach allows the UE to be configured to skip/or not to skip a PO regardless whether the UE was able to receive the PEI or not, which is also referred to as the following behaviors:
Behv-A:
   The PEI indicates that the UE is to monitor a PO in case a group or a subgroup to which the UE belongs to is paged,
   the UE is not required or expected to monitor the PO in case the UE does not detect a PEI at some or all of the PEI occasions for the PO
Behv-B
   The PEI indicates whether or not the UE is to monitor a PO,
   the UE is required to or expected to monitor a PO in case the UE does not detect a PEI at some or all PEI occasions for the PO.

Different designs for the PEI are considered, for example:
a Physical Downlink Control Channel, PDCCH, based PEI, and
a sequence-based PEI, like a Secondary Synchronization Signal, SSS, based PEI or a Tracking Reference Signal/Channel state information reference signal, TRS/CSI-RS, based-PEI.

Several issues regarding the implementation of the PEI are discussed in the following conventional technology documents:
R1-2100168, Oppo, Potential Paging Enhancements
R1-2100216, Huawei, High Silicon, Paging Enhancement(s) for UE Power Saving in IDLE/INACTIVE Mode
R1-2100392, CATT, Paging Enhancement for UE Power Saving
R1-2100452, Vivo, Paging Enhancements for IDLE/INACTIVE Mode UE Power Saving
R1-2100523, ZTE, Sanechips, Discussion on Power Saving Enhancements for Paging
R1-2100591, Mediatek Inc., Design of Paging Early Indication for IDLE/INACTIVE Mode UE Power Saving
R1-2100662, Intel Corporation, On Paging Enhancements for UE Power Saving,
R1-2100866, Sony, Paging Enhancements for IDLE/INACTIVE,
R1-2100903, LG Electronics, Discussion on Potential Paging Enhancements
R1-2100998, Lenovo, Motorola Mobility, Paging Enhancement for UE Power Saving,
R1-2101052, CMCC, Discussion on Paging Early Indication Design,
R1-2102991, Xiaomi, Paging enhancement for power saving,
R1-2101474, Qualcomm Incorporated, Paging Enhancements for IDLE/INACTIVE Mode UE Power Saving
R1-2101555, Ericsson, Design of Paging Enhancements
R1-2101622, NTT Docomo, Inc., Discussion on Paging Enhancements
R1-2101664, Nokia, Nokia Shanghai Bell, Evaluation of Potential Paging Enhancements

The PEI may be transmitted by the gNB to certain UEs operating in a power saving mode. Several types or categories of user devices or UEs may be encountered in the wireless communication system. For example, there are so-called full-powered UEs that are provided with a permanent power supply, like vehicular UEs obtaining power from a vehicle's battery. For such UEs, energy consumption is not an issue. Other user devices or UEs, like hand-held UEs, do not have a permanent power supply but are battery driven so that energy consumption needs to be considered. Also, there may be so-called Reduced Capability, RedCap, user devices or UEs having less capabilities when compared to other UEs, e.g., to enhanced Mobile BroadBand, eMBB, UEs. The capabilities concerned may include a maximum bandwidth such a UE may support. For example, when operating in Frequency Range 1, FR1, the UE may support a maximum of 20 MHz bandwidth, and when operating in Frequency Range 2, FR2, the UE may support up to 100 MHz bandwidth. Further requirements of a RedCap UE may include one or more of the following:
Device complexity: reduced costs and complexity when compared to high-end eMBB and Ultra Reliable Low Latency Communication, URLLC, devices.
Device size: for most use cases device design with compact form factor is decried.
Deployment scenarios: support of all FR1/FR2 bands for Frequency Division Duplexing, FDD, and Time Division Duplexing, TDD.

RedCap UEs may comprise also industrial sensors or wearables using SL communication to communicate with other UEs directly. For example, wearables may use SL communication to communicate with cars or other wearables directly.

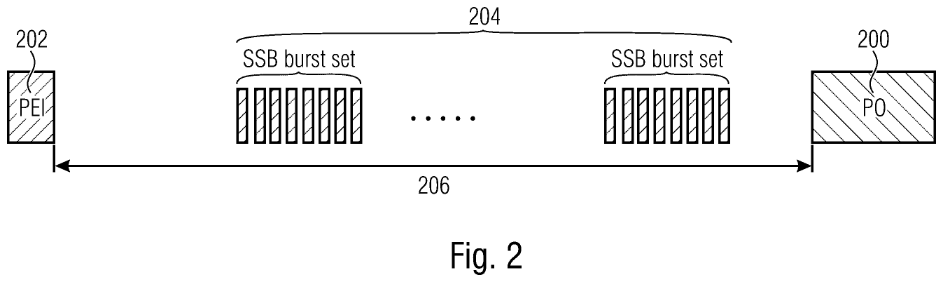

Any of the above mentioned UEs or any other UE that desires to save energy may make use of the PEI for enhancing the power saving, provided PEI is supported by the cell on which the UE camps. The UE may process the PEI before performing a full re-synchronization procedure, like processing one or more of the synchronization signal block, SSB, the system information block 1, SIB1, and the master information block MIB. Only in case the PEI indicates that the UE is to expect a paging in an upcoming PO, the UE actually performs the full re-synchronization procedure in order to process the PO, otherwise, i.e., in case the PEI indicates that the UE is not to expect a paging in an upcoming PO, the UE does not perform the full re-synchronization procedure, thereby avoiding the costs, for example in terms of energy consumption or battery lifetime associated with the re-synchronization procedure. FIG. 2 illustrates the concept of employing a PEI. FIG. 2 illustrates an upcoming paging occasion 200 for a certain UE being located within a cell of a wireless communication network and being served by a gNB. The PO 200 is also referred as the above-mentioned upcoming PO. The gNB serving the cell in which the UE is located, also sends the PEI 202 ahead of the upcoming PO 200 so as to indicate towards the UE whether the upcoming PO 200 includes a paging message dedicated to the UE or whether no such paging message is to be expected in the upcoming PO 200. In case the PEI 202 indicates a paging message to be expected in the upcoming PO 200, the UE starts the above-mentioned procedure to be set up for the processing of the PO which may include the above-mentioned re-synchronization with the network on the basis of one or more SSBs indicated at 204 in FIG. 2. FIG. 2 further illustrates the time gap 206 between the PEI 202 and the upcoming PO 200. For example, a UE camping on a certain cell may not have any data to be transmitted and, therefore, may enter into a power saving mode, like the DRX mode. The PO 200 and the PEI 202 are received by the UE during an ON duration of the DRX cycle, i.e., the UE leaves the sleep mode at a time at which the PEI 202 is expected by the UE and remains outside the sleep mode until the end of the paging occasion 200 in case the PEI indicate that the UE is to receive a paging message during the PO. Otherwise, in case the PEI indicated that the upcoming PO include no paging message for the UE, it may return back to the sleep mode after processing the PEI, thereby saving power or battery lifetime.

While the sending of the PEI provides advantages with regard to the actions to be taken at a UE in terms of monitoring/skipping a PO, there may be situations in which a PEI is received and the UE monitors the corresponding or upcoming PO for the paging message but no paging message is determined or detected by the UE. This is also referred to as a blocking that may occur due to the fact that multiple UEs are to be paged during the paging occasion. Thus, despite the fact that that a PEI is received at the UE indicating that the UE is to expect a paging message at the upcoming PO, such a paging message may be blocked so that despite the use of the PEI a waste of energy occurred due to the non-successful detection of the paging message. In addition, the timing of the PEI before the PO may be critical as the UE needs sufficient time to be set up for processing the PO, for example for monitoring and decoding possible paging messages. For example, in case a UE has a low signal to interference plus noise ratio, SINR, more SSB occasions need to be present before the PO when compared to a UE having a higher SINR. Moreover, a UE that is operating in accordance with the PEI, approach may get out of range of the gNB that supports the PEI procedure and may be in an area in which the PEI procedure is not supported. In this case, the UE never receives any PEI in the new cell and, as a consequence, never waked up for listening to a paging message.

The present invention provides various aspects for enhancing the PEI, especially for addressing the above drawbacks found in known approaches.

### First Aspect

A first aspect of the present invention addresses the above-mentioned blocking of paging messages. In accordance with embodiments, in case a UE receives a PEI indicating that the UE is to expect a paging message for the UE in an upcoming PO, but the UE was not able to detect such a paging message in the upcoming PO, the UE is allowed to monitor one or more POs following the upcoming PO thereby allowing for a reduction of the blocking rate as it is assumed that it is likely that the paging message is received in pone of the following POs.

### Second Aspect

A second aspect of the present invention addresses a situation when a UE receives the PEI at a time that is not sufficiently ahead of the PO so as to allow the UE to setup for a correct or successful monitoring of the PO, for example there is not enough time to perform the steps needed for the re-synchronization with the network. Embodiments of the second aspect of the present invention address this by allowing the UE to determine whether a time gap between the PEI and the PO is of sufficient length and, in a case it is not, to either skip the upcoming PO completely or to skip the upcoming PO and process a PO following the upcoming PO, for example the next or any later PO.

### Third Aspect

A third aspect of the present invention addresses situations in which a UE does not receive any paging signals or paging messages, for example in case the PEI indicates that no paging message is to be expected in an upcoming PO. To address the problem that in such situations, the UE may not wake-up as desired, in accordance with embodiments of the third aspect, the UE is configured or preconfigured with different PO configurations, each configuration having a different PO density. For example, for one PO configuration, a first number of POs is provided, like a single PO, and in case no paging message is received, the UE may decide to switch to the second PO configuration in which more than one PO is provided which are monitored by the UE thereby ensuring that the UE may be properly paged.

### Fourth Aspect

A fourth aspect of the present invention addresses the problem that a cell of a wireless communication network may support the PEI or not, i.e., the respective cell configurations may differ. In case a UE being, for example, in the RRC_INACTIVE state, moves from one cell supporting PEI to a cell not supporting PEI, the UE needs to adapt to the respective configuration accordingly. In accordance with embodiments of the fourth aspect of the present invention, the UE knows about a PEI support of a cell based on a list of cells for a certain tracking area. The UE determines for a cell on which the UE camps whether it supports PEI or not using the list. This allows the UE to adopt to the appropriate setting automatically without the need for reading SIB information and/or for moving into the RRC_ACTIVE state for obtaining the information needed. In other words, in accordance with the fourth aspect of the present invention, power saving when using the PEI approach is further improved when switching from cells with PEI support to cells without PEI support or vice versa as it is not necessary to query the cell for information about the support/non-support, rather, on the basis of the list this may be determined autonomously by the UE so that unnecessary control signaling overhead is avoided.

### Fifth Aspect

A fifth aspect of the present invention addresses problems encountered when operating the UE in accordance with different behaviors, e.g., in accordance
with a first behavior or a second behavior, wherein in accordance with the first behavior the UE is to monitor one or more POs regardless if the PEI is received or not, and in accordance with the second behavior, the UE is to monitor one or more POs if the PEI indicates that the UE is to expect a paging signal in the upcoming PO, or
the above-described behavior-A or behavior-B.

Embodiments of the fifth aspect of the present invention address potential problems by allowing the UE, which operates in accordance with one of the behaviors, to switch from one of the behaviors to another one of the behaviors responsive to a certain event.

### Sixth Aspect

A sixth aspect of the present invention addresses problems arising from the fact that different UEs may require the PEI associated with a certain upcoming PO to be provided at different times ahead of the upcoming PO dependent on how fast the UE is capable to be set up for carrying out the monitoring of the PO. For example, a first type of UE may require more time while a second type of UE may require less time, however, sending a PEI for each of the UEs leads to an undesired signaling overhead. Embodiments of the sixth aspect of the present invention address this issue by making use of a PEI that is shared among a plurality of UEs wherein the respective POs associated with the UEs are located at different times.

### Seventh Aspect

A seventh aspect of the present invention addresses the issue that a certain UE may require more time for being set up or prepared to carry out a monitoring of a PO indicated by a PEI as including a paging message for the UE. Embodiments of the seventh aspect address this problem by allowing for a reduction of the time required for setting up the UE for PO monitoring by providing in addition to the PEI additional information which reduces the duration needed for the UE to be in a position to monitor the PO.

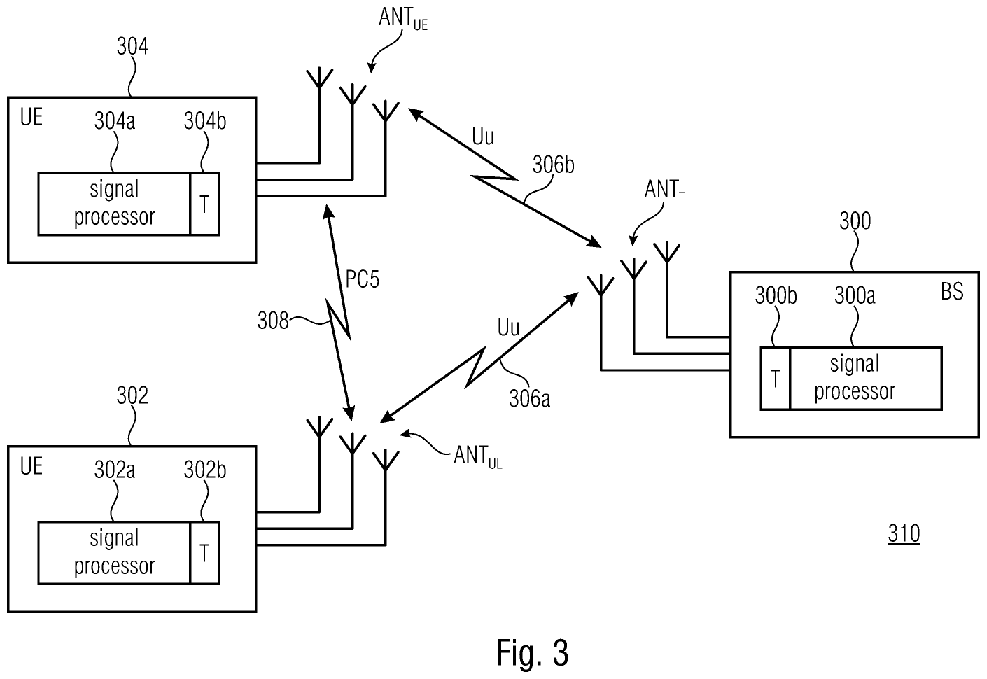

Embodiments of the present invention may be implemented in a wireless communication system as depicted in FIGS. 1A-1B including base stations and users, like mobile terminals or IoT devices. FIG. 3 is a schematic representation of a wireless communication system including a transmitter 300, like a base station, and one or more receivers 302, 304, like user devices, UEs. The transmitter 300 and the receivers 302, 304 may communicate via one or more wireless communication links or channels 306a, 306b, 308, like a radio link. The transmitter 300 may include one or more antennas ANT_{T} or an antenna array having a plurality of antenna elements, a signal processor 300a and a transceiver 300b coupled with each other. The receivers 302, 304 include one or more antennas ANT_{UE} or an antenna array having a plurality of antennas, a signal processor 302a, 304a, and a transceiver 302b, 304b coupled with each other. The base station 300 and the UEs 302, 304 may communicate via respective first wireless communication links 306a and 306b, like a radio link using the Uu interface, while the UEs 302, 304 may communicate with each other via a second wireless communication link 308, like a radio link using the PC5/sidelink, SL, interface. When the UEs are not served by the base station or are not connected to a base station, for example, they are not in an RRC connected state, or, more generally, when no SL resource allocation configuration or assistance is provided by a base station, the UEs may communicate with each other over the sidelink, SL. The system or network of FIG. 3, the one or more UEs 302, 304 of FIG. 3, and the base station 300 of FIG. 3 may operate in accordance with the inventive teachings described herein.

### First Aspect

### Monitoring of Additional POs in Case a Paging Message Cannot be Detected Form the PEI Indicated PO

The present invention provides a user device, UE, for a wireless communication network,
wherein the UE is to monitor one or more paging occasions, POs, for a paging signal directed to the UE by a base station of the wireless communication network,
wherein the UE is to receive, ahead of an upcoming PO, a paging early indication, PEI, the PEI indicating whether the UE is to expect a paging signal in the upcoming PO, and
wherein, in case the PEI indicates that the UE is to expect a paging signal in the upcoming PO and the UE does not detect the paging signal in the upcoming PO, the UE is to process one or more POs following the upcoming PO.

### Second Aspect

### PEI-PO Minimum Timing

The present invention provides a user device, UE, for a wireless communication network,
wherein the UE is to monitor one or more paging occasions, POs, for a paging signal directed to the UE by a base station of the wireless communication network,
wherein the UE is to receive, ahead of an upcoming PO, a paging early indication, PEI, the PEI indicating whether the UE is to expect a paging signal in the upcoming PO, and
wherein, in case a time gap between the PEI and the PO is less than a certain duration, the UE is to
   skip the upcoming PO, or
   skip the upcoming PO and process a PO following the upcoming PO.

In accordance with embodiments, the certain duration is a minimum time the UE requires to be set up for processing the upcoming PO.

In accordance with embodiments, setting up the UE for processing the upcoming PO comprises a re-synchronization procedure, e.g., processing of a Synchronization Signal Block, SSB, and/or a System Information Block 1, SIB1, and/or a Master Information Block, MIB.

In accordance with embodiments, the certain duration is based on one or more of the following parameters:
a PO periodicity, e.g., at least k×SSB, k being an integer,
a SSB periodicity,
a UE capability, e.g., a processing capability defining a lower boundary for the duration,
a DRX periodicity or a DRX offset,
a channel quality, e.g., a Reference Signal Received Power, RSRP, or a Signal to Interference plus Noise Ratio, SINR.

In accordance with embodiments, responsive to determining an increase in the certain duration, the UE is to perform one or more of the following:
monitor one or more regular paging occasions regardless of a PEI, e.g., until the UE is signaled a new value for the certain duration from the base station of the wireless communication network,
connect to the base station of the wireless communication network, e.g., using a Random Access CHannel, RACH, procedure,
indicate the increase to the base station of the wireless communication network,
in response to receiving a PEI, connect to the base station of the wireless communication network, e.g., using the RACH procedure, without monitoring the upcoming PO.

In accordance with embodiments, the UE is to indicate, e.g., to the base station of the wireless communication network, if the UE supports an indication of the certain duration.

In accordance with embodiments, in case a time gap between the PEI and the PO is equal to or more than the certain duration, the UE is to process the upcoming PO.

In accordance with embodiments, the UE is to indicate, e.g., to the base station of the wireless communication network, if the UE supports PEIs.

The present invention provides a base station for a wireless communication network, the wireless communication network comprising one or more user devices, UEs, the UE to monitor one or more paging occasions, POs, for a paging signal directed to the UE by the base station, and wherein the UE requires a certain duration to be set up for processing an upcoming PO,
wherein the base station is to send, ahead of the upcoming PO, a paging early indication, PEI, the PEI indicating whether the UE is to expect a paging signal in the upcoming PO, and
wherein the base station is to send the PEI such that the PEI is received at the UE at least at the certain duration of the upcoming PEI.

### Third Aspect

### PEI Indicated PO Configuration

The present invention provides a user device, UE, for a wireless communication network,
wherein the UE is to monitor one or more paging occasions, POs, for a paging signal directed to the UE by a base station of the wireless communication network,
wherein the UE is configured or preconfigured with a plurality of PO configurations, the plurality of PO configurations comprising at least a first PO configuration and a second PO configuration, and a first density of POs defined by the first PO configuration being lower than a second density of POs defined by the second PO configuration, and
wherein the UE is to switch between the first and second PO configurations responsive to one or more certain events.

In accordance with embodiments, the UE is to switch from the first PO configuration to the second PO configuration responsive to the one or more certain events.

In accordance with embodiments, the UE is to receive, ahead of an upcoming PO, a paging early indication, PEI, the PEI indicating whether the UE is to expect a paging signal in the upcoming PO, and the certain event includes one or more of the following:
the UE does not detect the paging signal in the upcoming PO,
the UE receives a certain PEI.

In accordance with embodiments, the one or more certain events include a channel condition.

The present invention provides a base station for a wireless communication network, the wireless communication network comprising one or more user devices, UEs, the UE to monitor one or more paging occasions, POs, for a paging signal directed to the UE by the base station,
wherein the base station is to configure the UE with a plurality of PO configurations, the plurality of PO configurations comprising at least a first PO configuration and a second PO configuration, and a first density of POs defined by the first PO configuration being lower than a second density of POs defined by the second PO configuration, and
wherein the base station is to receive from the UE a signaling indicating a switch between the first and second PO configurations at then UE.

### Fourth Aspect

### PEI Tracking Area

The present invention provides a user device, UE, for a wireless communication network,
wherein the UE is to monitor one or more paging occasions, POs, for a paging signal directed to the UE by a base station of the wireless communication network,
wherein the UE comprises a list of cells of the wireless communication network supporting a paging early indication, PEI, the PEI indicating whether the UE is to expect a paging signal in an upcoming PO, and
wherein the UE is
   to determine a current cell on which the UE currently camps,
   to expect receiving a PEI ahead of an upcoming PO, in case the current cell is in the list of cells, and
   not to expect receiving a PEI, in case the current cell is not in the list of cells.

In accordance with embodiments, the list of cells supporting a PEI includes a list of cell identities, IDs, and wherein, to determine the current cell on which the UE currently camps, the UE is to extract the cell ID, e.g. a physical cell ID or a SIB1 cell ID, of the current cell from a Synchronization Signal Block, SSB, e.g., from the Primary Synchronization Signal, PSS, sequence and/or from the Secondary Synchronization Signal, SSS, sequence, and/or from a physical broadcast channel, PBCH, and/or from the system information block, SIB.

In accordance with embodiments, the UE is not to expect receiving a PEI from a cell, in case of
receiving from the cell a cell ID, e.g. in PSS, SSS, PBCH, or SIB, that is not in the list of cell IDs, or
a PSS and/or a SSS associated with a cell is received at a received power level below a minimum received power level, e.g., a Reference Signal Received Power, RSRP, or a Signal to Interference plus Noise Ratio, SINR.

In accordance with embodiments, the UE is
configured with the list of cells supporting the PEI by a base station of the wireless communication network, e.g., by a Radio Resource Control, RRC, signaling, or
preconfigured with the list of cells supporting the PEI by the wireless communication network, e.g., by a broadcast signaling.

In accordance with embodiments, the UE is to create the list of cells supporting the PEI responsive to receiving from a plurality of cells information, e.g., a System Information Block, SIB, and/or a Master Information Block, MIB, indicating the cell ID and that the cell supports the PEI, and storing the information.

In accordance with embodiments, the UE is configured or preconfigured with a specific duration, and wherein the UE is to monitor and decode a PEI for the specific duration.

### Fifth Aspect

### Triggering Conditions on UE Behavior on PEI

The present invention provides a user device, UE, for a wireless communication network,
wherein the UE is to monitor one or more paging occasions, POs, for a paging signal directed to the UE by a base station of the wireless communication network,
wherein the UE is to receive, ahead of an upcoming PO, a paging early indication, PEI, the PEI indicating whether the UE is to expect a paging signal in the upcoming PO,
wherein the UE is to operate in accordance with a first behavior or a second behavior, wherein in accordance with the first behavior the UE is to monitor one or more POs regardless if the PEI is received or not, and in accordance with the second behavior, the UE is to monitor one or more POs if the PEI indicates that the UE is to expect a paging signal in the upcoming PO, and
wherein, when operating in accordance with the second behavior, the UE is to switch to the first behavior responsive to a certain event.

In accordance with embodiments, the UE is to switch from the second behavior to the first behavior in case one or more of the following applies:
a power level of the cell supporting PEI monitoring drops below or increases above a configured or preconfigured threshold,
the UE receives a signaling that a configured or preconfigured threshold for a paging load is reached,
the UE moves into a geographical area in which it is mandated to select the first behavior,
expiry of a configured or preconfigured timer, like a Behv_selection_timer, during which no PEI or no PEI indicating the UE is to expect a paging message was received by the UE

In accordance with embodiments, the UE is to receive a page load indication and/or the timer and/or information about the geographical area, and/or power level threshold from the wireless communication network, e.g., by the broadcast message, like the System Information Block 2, SIB2.

### Sixth Aspect

### PEI Repeated in Multiple Positions

The present invention provides a base station for a wireless communication network, the wireless communication network comprising a plurality of user devices, UEs, the UEs to monitor one or more paging occasions, POs, for a paging signal directed to the UEs by the base station, and wherein the plurality of UEs comprises at least a first UE and a second UE, the first UE to monitor a first PO at a first time, and the second UE to monitor a second PO at a second time, the second time being later than the first time,
wherein the base station is to send, ahead of the first PO, a paging early indication, PEI, the PEI indicating whether the first UE is to expect a paging signal in the first PO and whether the second UE is to expect a paging signal in the second PO.

In accordance with embodiments, a first time gap between the PEI and the first PO is shorter than a second a time gap between the PEI and the second PO.

In accordance with embodiments, a first channel quality, e.g., a Reference Signal Received Power, RSRP, or a Signal to Interference plus Noise Ratio, SINR, between the first UE and the base station is higher than a second channel quality between the second UE and the base station.

In accordance with embodiments, each of the first and second UEs requires a certain duration to be set up for processing the PO, and, responsive to determining an increase in the certain duration, the first or second UE is to perform one or more of the following:
monitor one or more regular paging occasions regardless of a PEI, e.g., until the UE signaled a new value for the certain duration to the base station of the wireless communication network,
connect to the base station of the wireless communication network, e.g., using a Random Access CHannel, RACH, procedure and indicate the increase,
in response to receiving a PEI, connect to the base station of the wireless communication network, e.g., using the RACH procedure, without monitoring the upcoming PO.

The present invention provides a user device, UE, for a wireless communication network,
wherein the UE is to monitor one or more paging occasions, POs, for a paging signal directed to the UE by a base station of the wireless communication network,
wherein the UE is to receive, ahead of an upcoming PO, a paging early indication, PEI, the PEI indicating whether the UE is to expect a paging signal in the upcoming PO, and
wherein the PEI further indicates whether a further first UE is to expect a paging signal in a further PO, the further PO being at a time different from the time of the upcoming PO for the UE.

### Seventh Aspect

### Fast Synchronization with Extra Signaling Assistance

The present invention provides a base station for a wireless communication network, the wireless communication network comprising one or more user devices, UEs, the UE to monitor one or more paging occasions, POs, for a paging signal directed to the UE by the base station, and wherein the UE requires a certain duration to be set up for processing an upcoming PO,
wherein the base station is to send, ahead of the upcoming PO,
   a paging early indication, PEI, the PEI indicating whether the UE is to expect a paging signal in the upcoming PO, and
   additional information for reducing the certain duration.

In accordance with embodiments, the additional information includes one or more of the following:
one or more additional Synchronization Signal Blocks, SSBs, that are transmitted more frequently than a regular SSB interval, e.g., additional or extra SSBs associated with the UEs may be transmitted in each antenna beam within the cell, like one SSB for each beam, or during beam sweeping only associated beams serving the UE to be paged, are switched on and other beams are not used,
a UE specific reference signal, e.g., a CSI-RS for a faster synchronization.

In accordance with embodiments, the base station is to send the additional information in case one or more of the following applies:
whenever the PEI indicates a paging message for the UE,
in case it is determined that the UE being paged needs one or more additional Synchronization Signal Blocks, e.g., based on a Reference Signal Received Power, RSRP, or a Signal to Interference plus Noise Ratio, SINR, or a UE category or a signaling received from the UE.

The present invention provides a user device, UE, for a wireless communication network,
wherein the UE is to monitor one or more paging occasions, POs, for a paging signal directed to the UE by a base station of the wireless communication network, the UE requiring a certain duration to be set up for processing an upcoming PO,
wherein the UE is to receive, ahead of an upcoming PO, a paging early indication, PEI, the PEI indicating whether the UE is to expect a paging signal in the upcoming PO, and
wherein the base station is to receive, ahead of the upcoming PO, additional information for reducing the certain duration.

### All Aspects

In accordance with embodiments,
in accordance with a first behavior, the PEI indicates that the UE is to monitor a PO in case a group or subgroup of UEs to which the UE belongs is paged during the PO, and
   the UE is not to monitor a PO in case the UE does not detect a PEI at some or all PEI occasions for the PO, or
in accordance with a second behavior, the PEI indicates whether or not the UE is to monitor a PO, and
   the UE is to monitor a PO in case the UE does not detect a PEI at some or all PEI occasions for the PO.

In accordance with embodiments, the UE is to operate in a power saving mode or is a UE having capabilities reduced when compared to another UE.

### System

The present invention provides a wireless communication system, comprising one or more of the inventive base stations and/or one or more of the inventive user devices, UEs.

### Methods

The present invention provides a method for operating a wireless communication network, the method comprising:
monitoring, by a user device, one or more paging occasions, POs, for a paging signal directed to the UE by a base station of the wireless communication network,
receiving, by the UE, ahead of an upcoming PO, a paging early indication, PEI, the PEI indicating whether the UE is to expect a paging signal in the upcoming PO, and
processing, by the UE, one or more POs following the upcoming PO, if the PEI indicates that the UE is to expect a paging signal in the upcoming PO and the UE does not detect the paging signal in the upcoming PO.

The present invention provides a method for operating a wireless communication network, the method comprising:
monitoring, by a user device, one or more paging occasions, POs, for a paging signal directed to the UE by a base station of the wireless communication network,
receiving, by the UE, ahead of an upcoming PO, a paging early indication, PEI, the PEI indicating whether the UE is to expect a paging signal in the upcoming PO, and
if a time gap between the PEI and the PO is less than a certain duration,
skipping the upcoming PO, or
skipping the upcoming PO and processing a PO following the upcoming PO.

The present invention provides a method for operating a wireless communication network, the method comprising:
monitoring, by a user device, one or more paging occasions, POs, for a paging signal directed to the UE by a base station of the wireless communication network, wherein the UE is configured or preconfigured with a plurality of PO configurations, the plurality of PO configurations comprising at least a first PO configuration and a second PO configuration, and a first density of POs defined by the first PO configuration being lower than a second density of POs defined by the second PO configuration, and
switching, by the UE, between the first and second PO configurations responsive to one or more certain events.

The present invention provides a method for operating a wireless communication network, the method comprising:
monitoring, by a user device, one or more paging occasions, POs, for a paging signal directed to the UE by a base station of the wireless communication network, wherein the UE comprises a list of cells of the wireless communication network supporting a paging early indication, PEI, the PEI indicating whether the UE is to expect a paging signal in an upcoming PO,
determining, by the UE, a current cell on which the UE currently camps,
expecting, by the UE, to receive a PEI ahead of an upcoming PO, in case the current cell is in the list of cells, and
not expecting, by the UE, to receive a PEI, in case the current cell is not in the list of cells.

The present invention provides a method for operating a wireless communication network, the method comprising:
monitoring, by a user device, one or more paging occasions, POs, for a paging signal directed to the UE by a base station of the wireless communication network,
receiving, by the UE, ahead of an upcoming PO, a paging early indication, PEI, the PEI indicating whether the UE is to expect a paging signal in the upcoming PO, wherein the UE is to operate in accordance with a first behavior or a second behavior, wherein in accordance with the first behavior the UE is to monitor one or more POs regardless if the PEI is received or not, and in accordance with the second behavior, the UE is to monitor one or more POs if the PEI indicates that the UE is to expect a paging signal in the upcoming PO, and
when operating in accordance with the second behavior, switching to the first behavior responsive to a certain event.

The present invention provides a method for operating a wireless communication network, the wireless communication network comprising a plurality of user devices, UEs, the UEs to monitor one or more paging occasions, POs, for a paging signal directed to the UEs by the base station, and wherein the plurality of UEs comprises at least a first UE and a second UE, the first UE to monitor a first PO at a first time, and the second UE to monitor a second PO at a second time, the second time being later than the first time, the method comprising:
sending by the base station, ahead of the first PO, a paging early indication, PEI, the PEI indicating whether the first UE is to expect a paging signal in the first PO and whether the second UE is to expect a paging signal in the second PO.

The present invention provides a method for operating a wireless communication network, the wireless communication network comprising one or more user devices, UEs, the UE to monitor one or more paging occasions, POs, for a paging signal directed to the UE by the base station, and wherein the UE requires a certain duration to be set up for processing an upcoming PO, the method comprising:
sending, by the base station, ahead of the upcoming PO,
   a paging early indication, PEI, the PEI indicating whether the UE is to expect a paging signal in the upcoming PO, and
   additional information for reducing the certain duration.

### Computer Program Product

Embodiments of the present invention provide a computer program product comprising instructions which, when the program is executed by a computer, causes the computer to carry out one or more methods in accordance with the present invention.

Embodiments of the present invention are now described in more detail. More specifically, the different aspects of the present invention are now described with reference to specific embodiments. It is noted that the subsequently outlined aspects and embodiments may be used independently from each other or may be combined. In the following description of embodiments of the present invention, reference is made to the paging early indication, referred to as PEI, and to the respective paging occasions, referred to as POs. Further, reference is made to an upcoming PO, which is a paging occasion associated with the PEI, for example, the next PO in time following the PEI.

### First Aspect

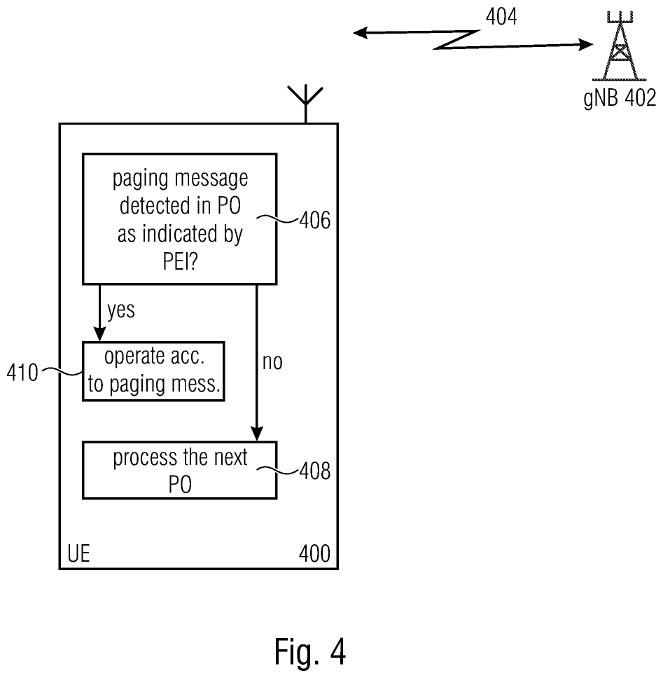

Embodiments of the first aspect of the present invention address the problem of blocking paging messages for a certain UE. The UE may be a regular UE operating in a power saving mode or a UE having, when compared to the regular UE, reduced capabilities, for example, a reduced processing power or the like. FIG. 4 illustrates a user device 400 in accordance with embodiments of the first aspect of the present invention. The UE 400 is located within a wireless communication network, for example, in a wireless communication network as described above with reference to FIGS. 1A-1B. FIG. 4 illustrates a part of a cell of such a network that is served by a base station 402. The UE 400 and the gNB 402 communicate with each other over a radio channel 404. The UE 400 may be in an INACTIVE or IDLE state from which it returns for monitoring paging occasions, POs, as described above with reference to FIG. 2. Ahead of a PO the gNB 402 sends via the radio channel 404 a paging early indication, PEI, to the UE 400 indicating whether the UE 400 is to expect receiving a paging message in an upcoming PO or not.

In accordance with embodiments of the first aspect of the present invention, responsive to the PEI indicating that the UE 400 is to expect receiving a paging message at the upcoming PO, it is determined, as is schematically represented at 406, whether a paging message has actually been detected in the PO that was indicated by the PEI. In other words, UE 400, responsive to receiving the PEI indicative of a paging message for the UE in the upcoming PO monitors or looks for a paging message in the upcoming PO, however, because multiple UEs may have to be paged, the paging message for UE 400 may be blocked, i.e., UE 400 does not detect a paging message in the upcoming PO. In this case, in accordance with embodiments of the present invention, to make sure that the UE 400 receives a paging message, rather than going back into the sleep state, UE 400 continues to monitor one or more POs following the PO from which it did not receive the expected paging message. For example, as is indicated at 408 in FIG. 4, UE 400, responsive to not detecting a paging message in the upcoming PO may continue to process the next PO, i.e., continues to monitor the following PO for a paging message for the UE 400. On the other hand, as is indicated at 410, in case the UE 400 detects from the upcoming PO the paging message, the UE 400 operates in accordance with the paging message received. For example, the paging message may cause the UE to receive a data transmission from the gNB 402 over the radio channel 404 and then go back into the sleep mode, or any other action.

Embodiments of the first aspect of the present invention are advantageous as they avoid the blocking issue which causes a UE that did not receive a paging message within a PO to go back to the sleep state or INACTIVE/IDLE mode until a new PEI is received, rather, the UE continues to monitor one or more POs following the PO indicated by the PEI, so that, eventually, the paging message may be detected by the UE and the blocking rate may be reduced.

The blocking issue may be due to a quality of the radio channel 404 between the gNB 402 and the UE 400 that does not allow with the UE 400 to successfully detect the paging message in the PO despite the fact that it was indicated to be expected by the PEI. Another reason for the blocking is that a high number of other UEs in the system need to be paged so that, for example, a control region or CORESET, where the paging messages are sent, may be overcrowded, i.e., the paging message is not included at the paging occasion at all, rather, due to the overcrowding of the CORESET, it may be transmitted at a later PO

### Second Aspect

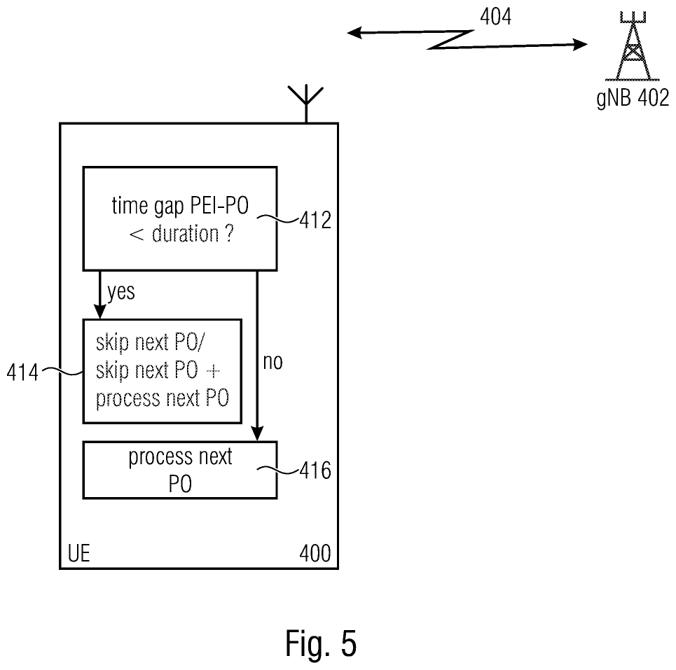

The second aspect addresses the issue of the timing between the PEI and the PO. FIG. 5 illustrates a UE 400 in accordance with embodiments of the second aspect of the present invention. FIG. 5, like FIG. 4, illustrates a cell of a wireless communication system and the UE 400 communicates with the gNB 402 over the radio channel 404. The UE 400 may be in a sleep mode from which it wakes up at certain periods for monitoring a PO, and ahead of the PO, the PEI is transmitted by the gNB 402 over the radio channel 404. The PEI, as described above with reference to FIG. 2, indicates whether UE 400 is to expect a paging message in the upcoming PO or not. The PEI is transmitted to the UE 400 ahead of the upcoming PO, such that there is a certain time gap, as illustrated in FIG. 2, between the PEI and the PO.

In accordance with embodiments of the second aspect of the present invention, UE 400 checks, as is illustrated at 412, whether the time gap between the PEI and the PO is less than a certain duration. In case the time gap is less than the certain duration, the UE 400, as is indicated at 414, may skip the next or upcoming PO or may skip the next or upcoming PO and process the next PO, i.e., one or more POs following the upcoming PO. On the other hand, in case it is determined that the time gap responds to the certain duration or is more than the certain duration, the UE 400, as is indicated at 416, processes the next or upcoming PO.

In accordance with embodiments, the time gap may be referred to as a minimum time gap between the PEI and the PO and in case the time gap is not fulfilled, the UE skips the PO or processes the next PO following the upcoming PO. The certain duration may be the minimum time required for the UE to be set up for processing the upcoming PO, i.e., the time the UE needs to move from a sleep mode into a mode in which it may monitor the upcoming PO, for example, the time required for the UE to carry out a re-synchronization procedure, for example, by processing one or more synchronization signal blocks, SSBs, and/or a system information block 1, SIB1, and/or a master information block, MIB.

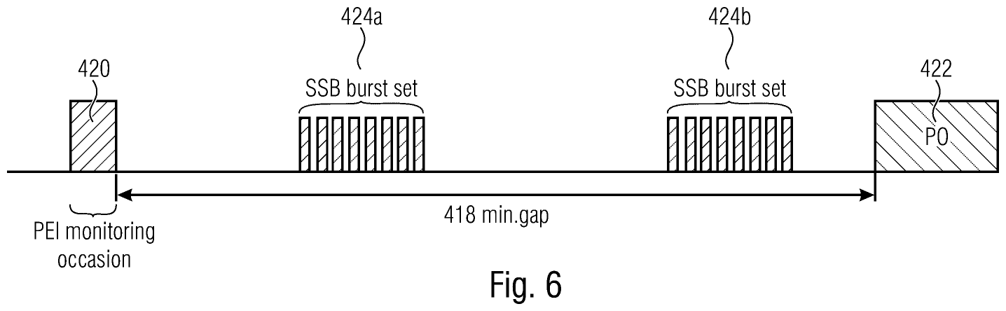

FIG. 6 schematically illustrates, in a similar way as FIG. 2, the time gap 418 between a PEI 420 received at the UE 400 from the gNB 402 over the radio channel 404, and the upcoming paging occasion, PO, 422. In the embodiment described with reference to FIG. 6, during the time gap 418 two SSB burst sets 424a and 424b are transmitted over the radio channel 404, which are used by UE 400, responsive to receiving the PEI 420 to resynchronize with the network to allow monitoring the PO 422. The time gap or required duration between the PEI and the PO may depend on one or more parameters, e.g., a pathloss experienced on the radio channel 404, and may be as follows:

N_SSB=1, if PL<=X_1

N_SSB=2, if PL<=X_2

N_SSB=3, if PL>X_2
with
N_SSB— number of SSBs required to synchronize
PL—pathloss, RSRP, received power

In accordance with embodiments, the certain duration the time gap needs to have may depend on various parameters, like one or more of the following parameters:
A periodicity of the PO which may be at least k×SSB.
A periodicity of the SSB.
For example, the more frequent a SSB is transmitted, the faster the UE may synchronize since it needs a minimum number of SSBs to get synchronized.
A capability of the UE 400, like its processing capabilities which may determine a lower boundary, i.e., the minimum time, of the time gap so that the UE, due to its processing capabilities, is able to process the signaling of the radio channel for re-synchronization
A periodicity of a discontinuous reception, DRX, mode in which the UE founded may operate or a DRX offset.
For example, the DRX tells the UE when to receive which may affect which SSBs have been received and which not.
A channel quality over the radio channel 404, for example, a value of the reference signal received power, RSRP or the signal to interference plus noise ratio, SINR the UE 400 experiences when receiving over the radio channel 404.
For example, in case the one or more parameters on the basis of which the UE 400 judges the channel quality are above a certain level, it is determined that any signaling is received successfully during a shorter time while a channel quality being lower may require the UE to listen to the radio channel for a longer period of time so as to ensure that all signaling for resynchronization of the UE are properly detected. In accordance with embodiments, the channel quality may be the main parameter which determines how many SSBs a UE needs to get synchronized.

Further embodiments of the second aspect of the present invention provide a gNB or base station that sends PEI so that it is received at the UE with the minimum time gap between the PEI and the PO. FIG. 5 schematically illustrates a gNB 402 in accordance with embodiments of the second aspect of the present invention. The gNB 402 is to serve one or more user devices, UEs, like UE 400 that monitors one or more paging occasions, POs, for a paging signal directed to the UE 400 by the gNB 402. As explained above, the UE 400 requires a certain duration to be set up for processing an upcoming PO, and the gNB 402 sends, ahead of the upcoming PO, a paging early indication, PEI, the PEI indicating whether the UE is to expect a paging signal in the upcoming PO. The gNB 402 sends the PEI such that the PEI is received at the UE at least at the certain duration of the upcoming PEI. The gNB 402 may configure the time or duration or, if it is preconfigured, it is aware of this time. Thus, in accordance with embodiments of the first aspect, the time gap required by the UE 400 is known at the gNB 402. For example, the UE 400 may signal the minimum time gap required between the PEI and the PO to the gNB 402 so that the gNB 402, responsive to receiving an indication of a minimum time gap for a certain UE may adjust the signaling of the PEI associated with the UE accordingly.

In accordance with embodiments, in case UE 400 determines a change in the duration of the time gap required for successfully processing an upcoming PO responsive to a PEI, for example, when determining that the time gap or the minimum time required between the PEI and the PO increases, the UE may monitor one or more regular paging occasions regardless of a PEI, e.g., until the UE signals or is signaled a new value for the certain duration to/from the gNB. The PEI feature is an additional power-saving feature because monitoring a PO requires a lot of power. A normal non-power-saving UE may monitor its POs and check whether there is paging or not. Thanks to the PEI feature which consumes less power than monitoring a PO, the UE only has to monitor the PEI and only in case there is an indication, it also monitors the associated PO. The time or duration by which the PEI is to precede the PO may be determined based on parameters such as the channel quality which may get worse. This causes the mentioned increase of the time gap however the gNB may not know this, e.g., it may not be aware of the channel situation at the UE if the UE did not have the opportunity to tell the gNB. This leads to a mismatch between the actual time at the UE and the estimated time at the gNB. To prevent any undesired behavior, the UE may switch to the normal or regular paging monitoring until it updated the gNB about the new situation. Normal or regular paging monitoring means that the UE monitors all POs but not the PEIs since they do not fulfill the timing requirements.

In accordance with other embodiments, in case of a change of the time gap, the UE may connect to the gNB 402, for example, by a random access channel, RACH, procedure. In accordance with embodiments, the UE may indicate the increase to the gNB so that the gNB 402 may send the PEI with an appropriate timing ahead of the PO. The indication of the increase may occur during the mentioned RACH procedure or by using any other available signaling procedure. For example, the UE 400 may determine changes in the channel quality or there may be a change in the DRX periodicity or DRX offset which requires a change in the minimum time gap between the PEI and the PO, and this may be signaled to the gNB accordingly. In accordance with other embodiments, the UE 400 may connect to the gNB 402 not immediately after determining a change of the minimum time gap, but in response to receiving a PEI.

In accordance with other embodiments, in case of a change of the time gap, responsive to receiving a PEI, the UE may connect to the base station of the wireless communication network, e.g., using the RACH procedure, without monitoring the upcoming PO. Thus, the UE receives a PEI but since the timing has changed and the upcoming PO may not fulfill the timing criterion anymore, the UE may not be able to monitor that PO. Hence, the UE simply ignores that PO, e.g., in the sense that there may be paging or there may be not (normally the UE only wake-up if there is a paging) and wakes-up at the next opportunity, i.e. performs the RACH. For example, the UE may provide an indication that the connection causes an insufficient time gap. If there is no paging to the UE, the network may set a larger time gap and indicate the UE can return to previous RRC state. If the paging is to that UE, the data can be delivered.

In accordance with other embodiments, the UE may indicate, e.g., to the base station of the wireless communication network, if it supports providing or receiving the indication of the certain duration, also referred to as the PEI duration indication. In accordance with embodiments, the information that the UE supports PEI duration indication or not may be part of the UE capabilities signaled to the network.

### Third Aspect

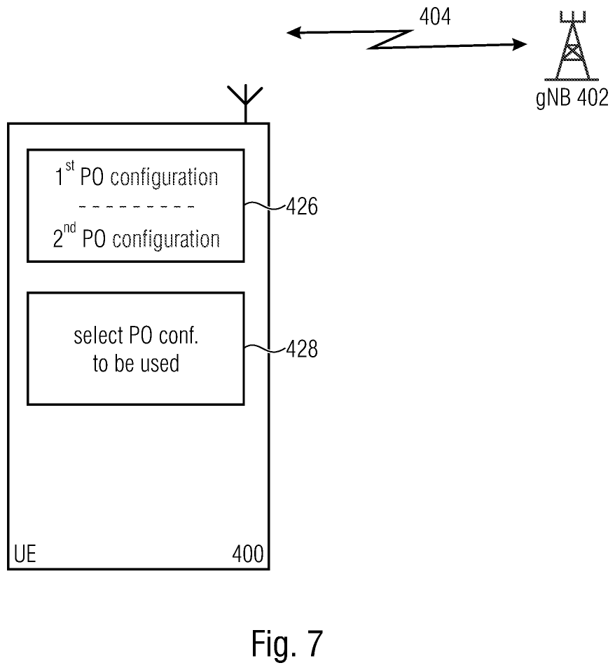

The third aspect of the present invention concerns the use of different PO configurations for addressing issues of blocked paging messages due to a bad channel condition or an overcrowding of a control region, like the CORESET. FIG. 7 illustrates a UE 400 in accordance with embodiments of the third aspect of the present invention. UE 400 is located within a cell of a wireless communication network that is served by gNB 402, and the connection between UE 400 and gNB 402 is via the radio channel 404. UE 400 is operating, as described above with reference to the other aspects, in a sleep mode from which it wakes at certain times for monitoring a paging occasion for paging messages.

In accordance with embodiments, UE 400 is configured or preconfigured with a plurality of PO configurations. In the embodiment depicted in FIG. 7, as is indicated at 426, the UE 400 is assumed to be configured or preconfigured with a first PO configuration and with a second PO configuration. In accordance with the first PO configuration, the paging occasions have a first density, while in accordance with the second PO configuration, the paging occasions have a second density, which may be different, e.g., higher or lower, than the first density. As is indicated at 428, dependent on one or more certain events, UE 400 may select from the two PO configurations one to be applied for the paging procedure.

Further embodiments of the third aspect of the present invention provide a gNB or base station that that configures a UE with different PO configurations and is informed by UE about a switching between them. FIG. 7 schematically illustrates a gNB 402 in accordance with embodiments of the third aspect of the present invention. The gNB 402 is to serve one or more user devices, UEs, like UE 400 that monitors one or more paging occasions, POs, for a paging signal directed to the UE 400 by the gNB 402. The gNB 402 configures UE 400 with the above described PO configurations, and receives from the UE a signaling indicating a switch between the PO configurations at then UE.

In accordance with embodiments, the first PO configuration providing POs with a low density may be a default configuration applied by UE 400, and only responsive to one or more certain events, the UE 400 switches from the first or default PO configuration to the second PO configuration which offers more POs, i.e., has a PO density higher than the PO density of the first PO configuration.

In accordance with further embodiments of the third aspect of the present invention, UE 400 may receive a PEI, as described with reference to FIG. 2 and FIG. 6 that indicates whether the UE is to expect or not to expect receiving a paging message in an upcoming PO. As described above with reference to the first aspect of the present invention, there may be situations in which the PEI for the UE 400 indicates that the UE is to expect at the upcoming PO a paging message, however, due to the channel quality or due to a high number of UEs to be paged, the actual paging message for the UE 400 may be blocked so that UE 400 does not detect any paging message or paging information at the upcoming PO.

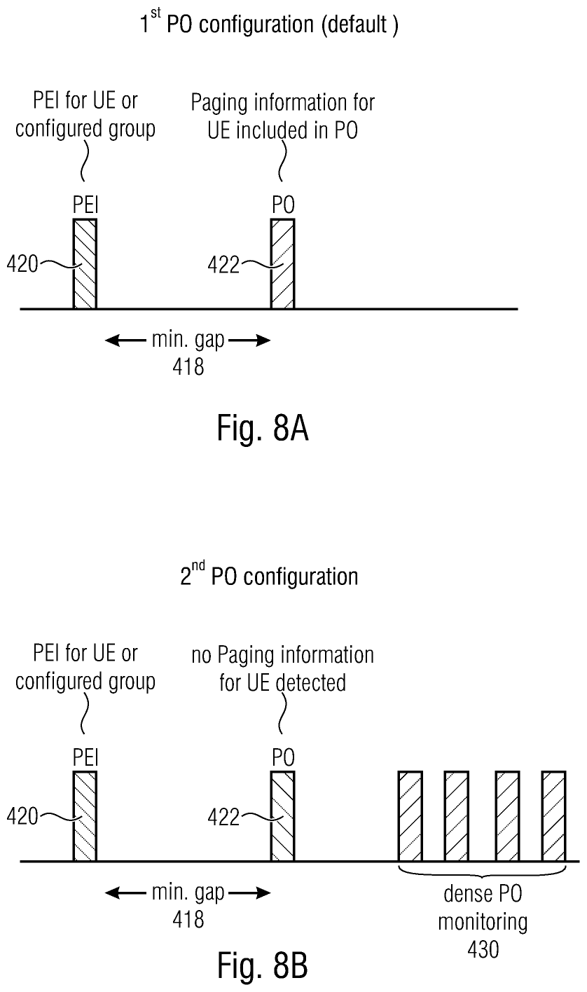

In accordance with embodiments, in such a scenario, UE 400 may switch from the first PO configuration to the second PO configuration. FIGS. 8A-8B illustrate an embodiment for such a switching. FIG. 8A illustrates a situation in which the UE 400 operates in accordance with the first or default PO configuration. Responsive to receiving a PEI 420 directed to the UE or to a group to which the UE belongs, the UE monitors the upcoming PO 422 for the paging information. FIG. 8B illustrates a situation in which the UE 400 switches to the second PO configuration. Again, the PEI 420 for the UE is received which indicates that the UE 400 is to expect receiving a paging message in the upcoming PO 422. However, for the above reasons the UE 400 does not detect a paging message or paging information at PO 422 and, therefore, switches from the first or default PO configuration to the second PO configuration in accordance with which additional POs are provided which are more dense, as is schematically illustrated at 430. FIG. 8B shows four POs labeled a, b, c, and d, which are closely spaced in time so as to increase the probability that the UE 400 obtains the required paging information from one of the POs 430.

In accordance with other embodiments, the UE 400 may switch from the first PO configuration to the second PO configuration not responsive to a failure in detecting the paging information at the PO 422 as illustrated in FIG. 8B. For example, in case the network is aware of a high number of paging messages to be send to many UEs, it may consider it likely that the UE 400 misses the paging information at the PO following the PEI and therefore, a certain PEI, for example a PEI with a unique format, may be sent to the UE 400 which, responsive to recognizing the specific format of the PEI or some specific information included in the PEI, automatically switches to the second PO configuration and skips monitoring the upcoming PO 422 but monitors the more dense POs 430 as illustrated in FIG. 8B for the paging information.

In accordance with other embodiments, the UE 400 may switch from the first PO configuration to the second PO configuration independent of receiving a PEI but dependent on a channel quality. For example, in case one or more of the parameters defining a channel quality are below a predefined threshold, the UE 400 may judge the channel quality to be not good enough for successfully detecting from the PO 422 the paging information and, therefore, switches from the first PO configuration to the second PO configuration and monitors the more dense POs 430 thereby increasing the chances to successfully decode from the more dense POs the paging information.

### Fourth Aspect

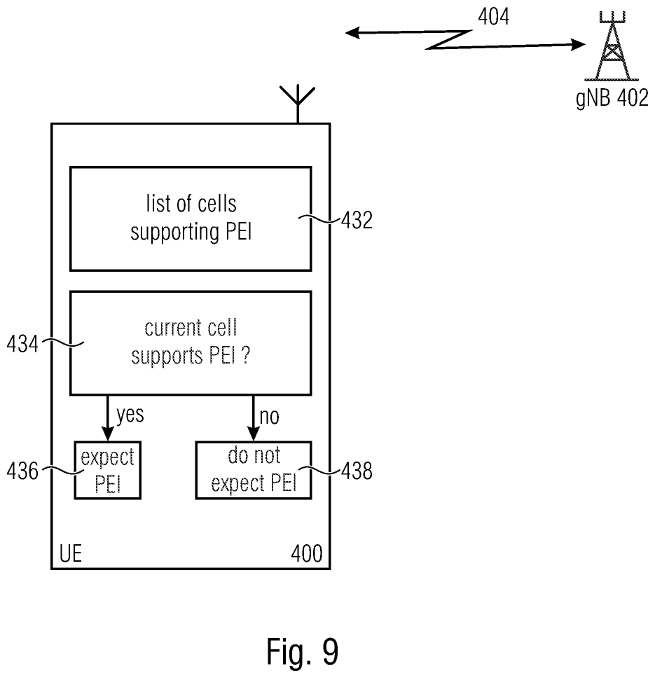

The fourth aspect addresses the issue that not all cells or areas of a wireless communication network may support the PEI. FIG. 9 illustrates a UE 400 in accordance with embodiments of the fourth aspect. As described above with reference to the previous aspects, UE 400 is located within a cell of the wireless communication system and communicates with a gNB 402 serving the cell over the wireless radio channel 404.

In accordance with embodiments of the fourth aspect of the present invention, UE 400 comprises a list 432 which indicates a set of cells or areas of the wireless communication network which support the PEI feature, i.e., those cells in which the UE 400 may expect receiving a PEI. UE 400 may be in a sleep mode from which it wakes up at regular intervals for monitoring paging occasions, and in accordance with the fourth aspect, UE 400 determines, as is indicated at 434, whether a current cell on which the UE 400 camps supports the PEI. This is determined on the basis of the list of cells 432, and in case the current cell supports PEI, UE 400 expects receiving a PEI ahead of a PO, as is indicated at 436. On the other hand, in case the UE 400 determines that the current cell does not support PEI, it does not expect receiving a PEI, as is indicated at 438.

Embodiments of the fourth aspect of the present invention are advantageous as they allow handling situations in which configurations of cells within a wireless communication network may be different or may change in terms of supporting PEI or not. For example, in case a UE, like UE 400, is in the RRC_INACTIVE state and moves from one cell in which PEI is supported to another cell which does not support PEI, conventionally, the UE needs to read the cell information to learn whether the PEI is supported or not. However, this requires the UE to communicate with the new cell so that additional power is needed. In accordance with the embodiments of the fourth aspect of the present invention, this drawback is avoided because the UE 400 is aware of the cells in the network which support PEI so that it becomes automatically aware whether it may expect receiving a PEI or not by simply determining the cell in which the UE is located and referring to the stored list. Thus, no communication with the gNB 402 for obtaining this information is required so that the additional communication between the UE 400 and the gNB 402 is avoided, thereby increasing the power saving capabilities.

In accordance with embodiments, the list of cells 432 includes a list of cell identities or cell IDs, and the UE 400 may determine the cell on which it currently camps by extracting the cell ID, e.g., a physical cell ID or a SIB1 cell ID, of the current cell from a Synchronization Signal Block, SSB, e.g., from the Primary Synchronization Signal, PSS, sequence and/or from the Secondary Synchronization Signal, SSS, sequence, and/or from a physical broadcast channel, PBCH, and/or from the system information block, SIB. In accordance with such embodiments, the UE assumes a cell not to be in the list 432 and does not expect receiving a PEI, in case
receiving from the cell a cell ID, e.g. in PSS, SSS, PBCH, or SIB, that is not in the list of cell IDs, or
a PSS and/or a SSS associated with a cell is received at a received power level below a minimum received power level, e.g., a Reference Signal Received Power, RSRP, or a Signal to Interference plus Noise Ratio, SINR.

In accordance with embodiments of the fourth aspect, UE 400 may be configured or preconfigured with the list 432. For example, it may be configured by the gNB 402 by a radio resource control, RRC, signaling. UE 400 may also be preconfigured with the list 432, for example, by a broadcast signaling.

In accordance with other embodiments, rather than being configured or preconfigured with the list 432, the UE 400 may generate the list by its own. For example, as the UE 400 moves through the network, i.e., camps on different cells, the UE reads the respective cell information, like the SIB or MIB that indicate a cell ID and whether the cell supports the PEI or not. For each cell the UE visits, it may store the information about the cell ID and whether PEI is supported or not in its memory, thereby generating the list 432. In accordance with embodiments, the UE may be configured or preconfigured with a specific duration, and the UE monitors and decodes a PEI for the specific duration.

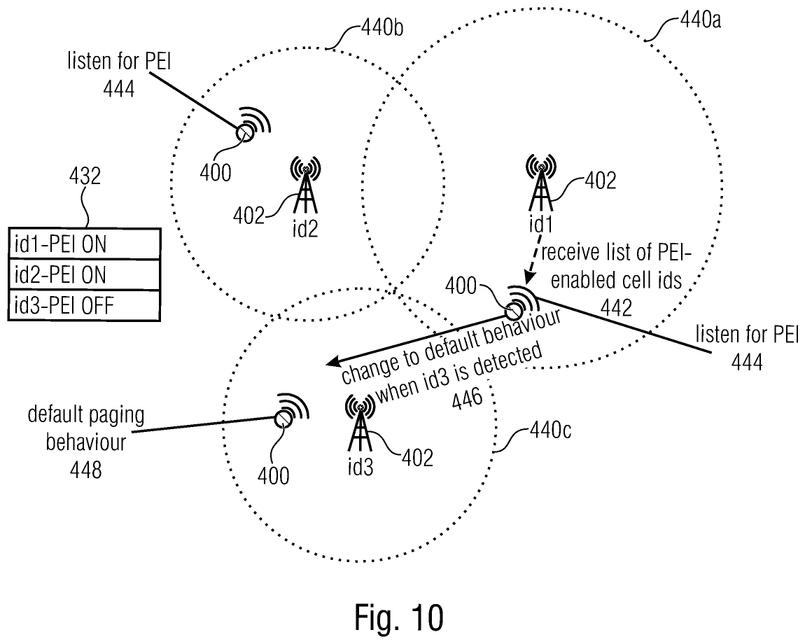

FIG. 10 illustrates a part of a wireless communication network implementing embodiments of the fourth aspect of the present invention. FIG. 10 illustrates three cells 440a-440c having the cell IDs id1, id2 and id3, respectively. Each cell 440a-440c is served by a gNB 402, and cells 440a and 440b are assumed to support the PEI feature while cell 440c is assumed not to support the PEI feature. FIG. 10, schematically, illustrates the list 432 indicating the cell IDs which support PEI, namely id1 and id2, and the cell IDs which do not support PEI, namely id3. In the embodiment of FIG. 10, it is assumed that the UE 400 is initially located in cell 440a and is configured with the list 432 by the gNB 402 of cell 440a, as is indicated at 442, for example, by RRC signaling. Based on the list 432, UE 400, when being located in cell 440a expects to receive a PEI ahead of a PO and, therefore, listens for a PEI, as is indicated at 444. In case UE 400 moves to cell 440b, UE 400 determines from the list 432 that this cell also supports PEI and, therefore, when camping on cell 440b, UE 400 also expects to receive a PEI and listens for the PEI, as is indicated at 442. In case UE 400 moves into cell 440c, it determines that this cell does not support PEI and, therefore, as indicated at 446, changes to a paging procedure not supporting PEI, which may also be referred to as a default or regular behavior. Thus, when camping on cell 440c, UE 400 operates in accordance with the default paging behavior as indicated at 448, i.e., it monitors PO locations without the use of a PEI.

As mentioned above, the advantage of the inventive approach is that in case the UE moves among different cells of the network, it is not required for the UE 400 to communicate with the respective base station or gNB for obtaining information whether PEI is supported or not, rather, this information is obtained, without signaling overhead, from the list 432 that is stored in the UE 400.

### Fifth Aspect

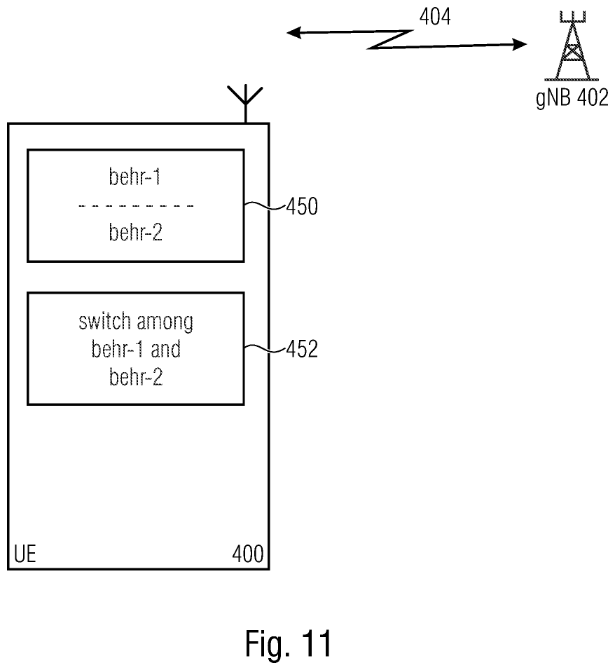

The fifth aspect addresses the above-described issues regarding a certain behavior a UE and how switching among the available behaviors is to be performed. FIG. 11 illustrates a UE in accordance with embodiments of the fifth aspect. UE 400 is located within a cell served by the gNB 402 and is connected to the gNB 402 over the radio channel 404, as also described with reference to the previous aspects. UE 400 may be in an energy saving mode and wake up only at certain times for monitoring a PO. UE 400 supports PEI and expects receiving a PEI ahead of an upcoming PO. As is indicated at 450, UE 400 may operate in accordance with a first behavior or a second behavior, wherein in accordance with the first behavior the UE is to monitor one or more POs regardless if the PEI is received or not, and in accordance with the second behavior, the UE is to monitor one or more POs if the PEI indicates that the UE is to expect a paging signal in the upcoming PO.

For example, the first behavior is how currently all UEs operate, i.e., it refers to the default or regular paging procedure in accordance with which all POs are monitored and the PEI feature is not used. The second behavior allows implementing the additional power saving feature by using the PEI, and in accordance with embodiments of the fifth aspect of the present invention, the UE may operate in accordance with the second behavior but is to switch back to the first behavior in case of a certain event. For example, the UE 400 may switch from the second behavior to the first second behavior in case one or more of the following applies:
a power level of the cell supporting PEI monitoring drops below or increases above a configured or preconfigured threshold.
For example, if the power of a cell, in which the PEI monitoring is configured, drops below a first threshold, the UE may switches to the first behavior, and if the power increases above a second threshold, which may be the same as or different form the first threshold, the UE may switch to the second behavior.
The UE receives a signaling that a configured or preconfigured threshold for a paging load is reached.
The UE moves into a geographical area in which it is mandated to select the first behavior,
Expiry of a configured or preconfigured timer, like a Behv_selection_timer, during which no PEI or no PEI indicating the UE is to expect a paging message was received by the UE.
For example, the UE switches to the legacy or first behavior if it did not receive anything on the PEI for a certain duration.

In accordance with other embodiments, the different behaviors may be the above-described behavior A, Behv-A, and behavior B, Behv-B. In accordance with Behv-A, a PEI indicates that the UE is to monitor a PO in case a group or a subgroup to which the UE belongs to is paged, and the UE is not required or expected to monitor the PO in case the UE does not detect a PEI at some or all of the PEI occasions for the PO. In accordance with Behv-B, the PEI indicates whether or not the UE is to monitor a PO, and the UE is required to or expected to monitor a PO in case the UE does not detect a PEI at some or all PEI occasions for the PO.

Behv-B may increase the burden on the network, as the UE skips monitoring POs when the PEI is not received correctly at the UE. On the other hand, Behv-A may increase the power consumption at the power-saving users since the POs will be monitored regardless the PEI is received or not. Further, switching from one behavior to the other may increase the signaling cost and power consumption on the network side and the UE side, respectively.

In accordance with further embodiment of the fifth aspect, an appropriate UE behavior corresponding to the PEI monitoring may be selected as follows:

Scenario 1: The PEI and Behv-A are configured for one or more or all UEs within a cell. The Behv-B is triggered if
the UE receives a parameter specifying that a threshold for the parameter (e.g., configured by the network) is reached, like a threshold for a power level of the cell (see above) or for a paging load (see also above), or
the UE moves into a geographical area in which is Behv-B is mandated to be selected, or
a configured or preconfigured Behv_selection_timer during which Behv-A is used expired, and the UE is mandated to select Behav-B.

Scenario 2: The PEI and Behv-B are configured for one or more or all UEs within a cell. The Behv-A is triggered when
the timer during which Behv-A is used is not expired
the UE receives a parameter specifying that a threshold for the parameter (e.g., configured by the network) is not reached, like a threshold for a power level of the cell (see above) or for a paging load (see also above), or
the UE moves into a geographical area in which is Behav-B is mandated to be selected, or
the already started Behv_selection_timer expired, and the UE is mandated to select Behv-A.

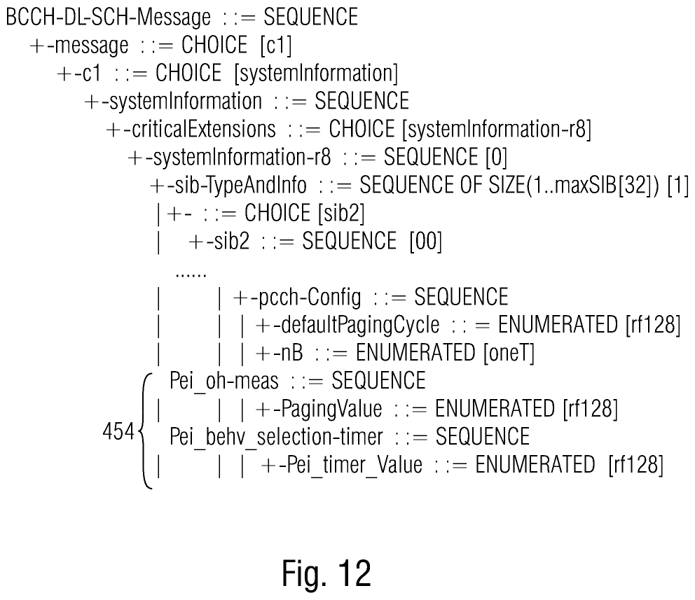

In accordance with embodiments, the UE may receive an indication of a load and/or an indication of the timer and/or information about the geographical area, and/or power level threshold from the wireless communication network, for example, by a broadcast message like the SIB2. FIG. 12 illustrates an example of an SIB2 including the parameters PEI_OH indicating a current paging load or paging load threshold, and the Behv_selection_timer, as is indicated at 454.

### Sixth Aspect

The sixth aspect of the present invention addresses the issue that when serving a plurality of UEs within a cell, the gNB may be required to send to each UE an individual PEI dependent on the minimum time gap (see the second aspect of the present invention) the UE requires the PEI to be received ahead of the upcoming PO.

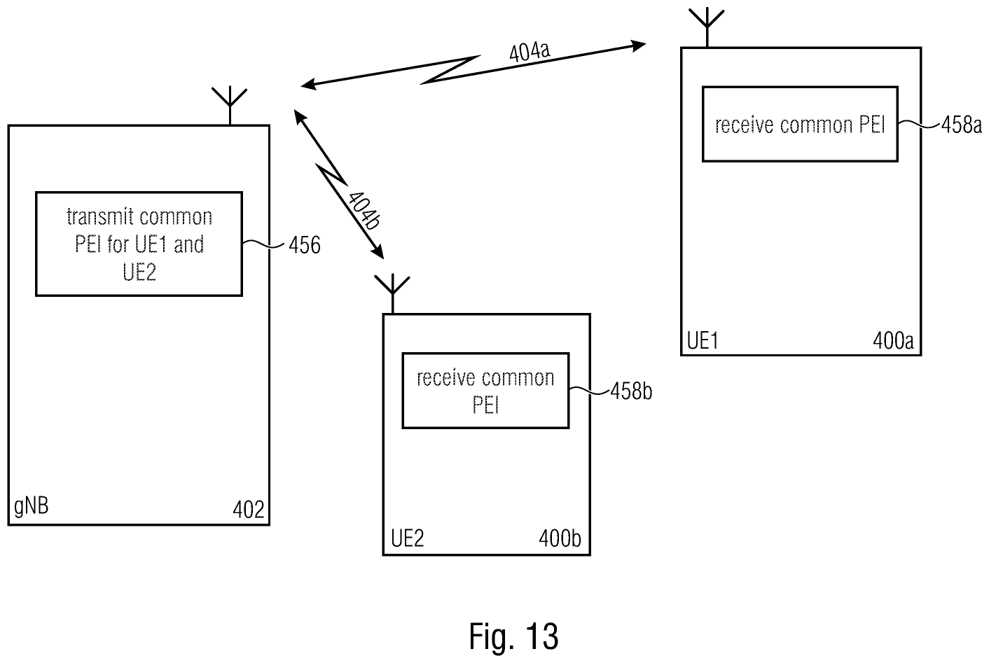

FIG. 13 illustrates embodiments of a gNB 402 and of a UE 400a, 400b, in accordance with embodiments of the sixth aspect of the present invention. FIG. 13 illustrates a part of a cell served by gNB 402 in which the UEs 400a and 400b are located and communicate with the gNB over the radio channels 404a and 404b. The UEs 400a and 400b are assumed to be in a sleep mode and to wake up at certain times for monitoring paging occasions. Also, the UEs are assumed to support the PEI.

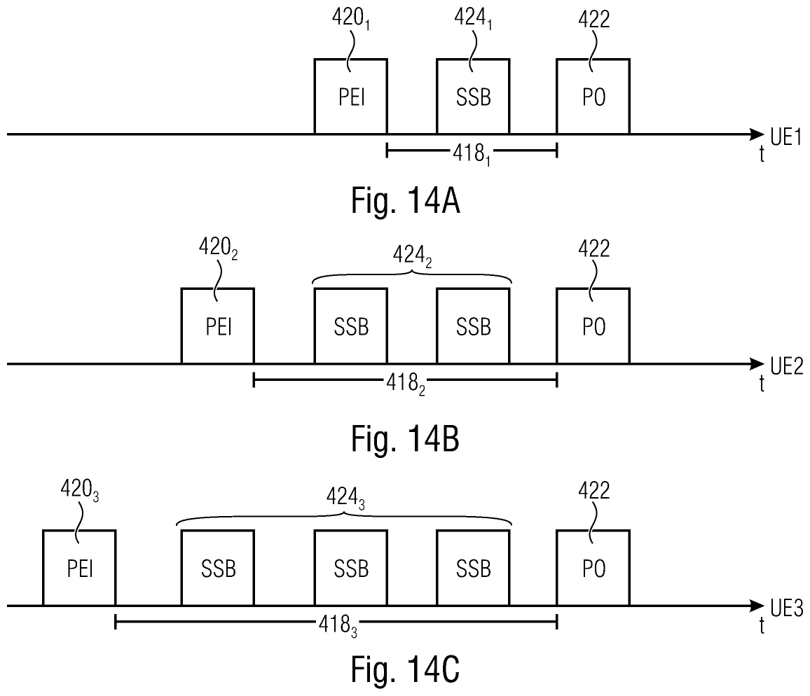

As described above, for example, with reference to the second aspect of the present invention, a PEI position for a certain UE may depend on certain parameters, like the UE capabilities, the SINR on the channel and the like. Dependent on the circumstances, some UEs may need more SSBs to synchronize to the network than others so as to be able to read the paging information at the upcoming PO associated with the PEI. Therefore for different UEs, respective PEIs may need to be send at multiple times so that the different UEs may be able to read the PEI at the required time. FIGS. 14A-14C illustrate an example of such a situation with reference to three UEs experiencing a high SINR, a medium SINR and a low SINR, respectively, on the radio channel between the respective UE and the gNB. As is illustrated in FIG. 14A, a UE experiencing a high SINR on the radio channel may receive the PEI 420₁ with a very short minimum gap 418₁ (see the above-described second aspect of the present invention), and in case the PEI 420₁ contains a paging indication, the UE reads the one SSB 424a and then the paging occasion 422. In case no PEI is received or the PEI indicates that there is no paging information for the UE, the UE returns in the sleep mode after processing of the PEI is completed. In FIG. 14B, the situation for a UE experiencing a medium SINR on the radio channel is illustrated and, when compared to FIG. 14A, such a UE is to wake up with a slightly larger gap 418₂ so as to allow the UE to read the two SSBs 424b in case the PEI 420₂ indicates that the PO 422 includes paging information for the UE. After reading the paging information at 422, the UE returns to sleep. Also, in case the PEI 420₂ indicates that no paging information is in PO 422, also the UE returns to the sleep mode without processing the SSBs and the PO. FIG. 14C illustrates an example of a UE experiencing a low SINR on the radio channel which requires a larger gap 418₃ when compared to the scenarios in FIG. 14A and in FIG. 14B so as to allow to read the three SSBs 424b for synchronizing with a network in case the PEI 420₃ indicates that the PO 422 holds paging information for the UE. After having read the paging information at 422, the UE returns to the sleep mode. Also, in case the PEI 420₃ indicates that no paging information is to be expected in the PO 422, the UE returns to sleep after processing the PEI 420₃. In other words, in case the PEI indicates that no paging information is to be expected, no processing of the SSBs 424a to 424c is performed for a re-synchronization of the UE, rather, it immediately goes back to the sleep mode.

For example, in FIG. 13, UE 400a is assumed to be a UE experiencing a high SINR as explained above with reference to FIG. 14A, and UE2 of FIG. 13 is assumed to be a UE experiencing a medium SINR as explained with reference to FIG. 14B. FIG. 14C illustrates a third UE not illustrated in FIG. 13 experiencing a low SINR on the radio channel. The respective UEs in FIGS. 14A-14C are provided with the PEI as close as possible to the PO 422 which allows setting the minimum gap 418 more aggressively for UEs experiencing a SINR that is higher than the SINR experienced by other UEs, thereby allowing such UEs to save more power. However, despite the fact that this approach allows some additional power saving, it comes at the cost of dedicating additional resources for the different PEIs 420₁-420₃.

To address this, in accordance with embodiments of the sixth aspect of the present invention, the gNB 402 sends or transmits a common PEI for different UEs, as is indicated at 456 in FIG. 13. The common PEI is transmitted to UE1 and UE2 which receive the common PEI, as is indicated at 458a and 458b. UE1 and UE2 monitor paging occasions which are offset from each other in time. For example, UE1 monitors a PO that occurs earlier than a PO monitored by UE2 which allows using a common PEI that is transmitted ahead of the PO monitored by UE1 thereby creating a first gap between the PEI and the PO monitored by UE1 and a second, larger gap between the PEI and the PO monitored by UE2 thereby allowing the respective UEs to re-synchronize with the network in accordance with the circumstance or the capabilities by using only a common or a single PEI. This reduces the signaling overhead while still allowing for the power saving by the high SINR UE1. In other words, in accordance with embodiments, the advantages of placing a PEI as close as possible to an upcoming PO for a certain UE may be maintained without the spending of the addition resources by serving UEs belonging to different POs with a common PEI or by multiplexing UEs belonging to different POs on the same PEI.

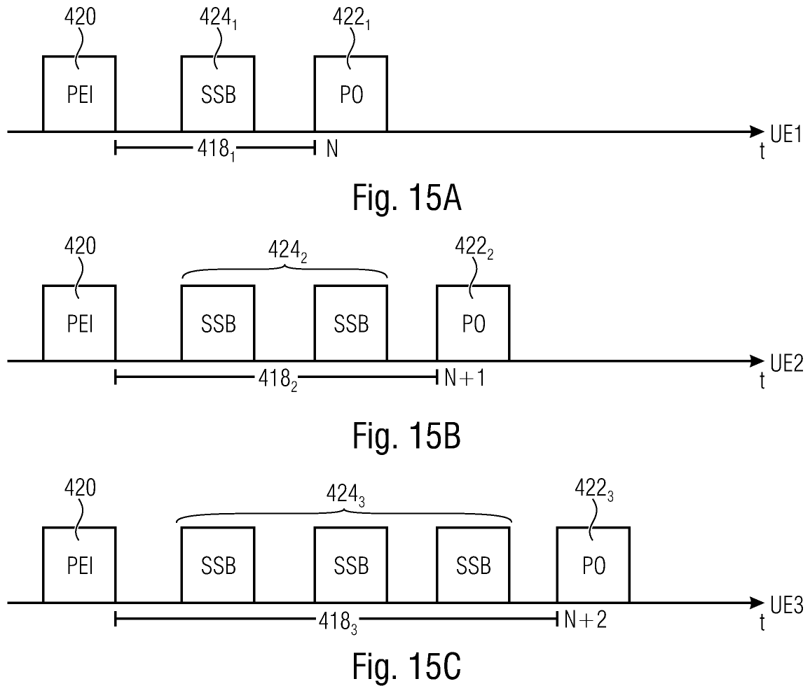

FIGS. 15A-15C illustrate the use of a common PEI 420 in accordance with embodiments of the present invention. In a similar way as in FIGS. 14A-14C, also FIGS. 15A-15C illustrate the situation for three UEs experiencing a high SINR on the radio channel, like UE1, a medium SINR on the radio channel like UE2 and a low SINR on the radio channel like UE3. UE1 to UE3 share a PEI 420 for the respective POs 422₁-422₃ that are located at different times or at different frames. For example, in FIGS. 15A-15C it is assumed that a PO 422₁ for the high SINR UE1 is at frame N, while the PO 422₂ for the medium SINR UE2 is at frame N+1 and the PO 422₃ for the low SINR UE3 is at a frame N+2. For these POs, the common PEI 420 is transmitted by the gNB at a minimum time ahead of the PO 422₁ for the high SINR UE1. The PEI includes the information for UE1 to UE3 whether a paging message or paging information is provided in the associated POs 421, 422 and 422₃, respectively.

Thus, in accordance with embodiments of the sixth aspect of the present invention, the advantage of providing the PEI at an appropriate time gap 418₁-418₃ ahead of the associated PO 422₁-422₃ is maintained, thereby allowing the respective UEs to save more power dependent on the experienced SINR, and, at the same time, the overhead in resources employed in conventional approaches is avoided as only a single or common PEI 420 is to be transmitted, i.e., the same amount of resources are used for the PEI as may be the case if all UEs had the same gap between PEI and PO.

In accordance with further embodiments, the respective UEs may monitor the gap 418 between the PEI and the PO determines a change in the duration of the time gap required for successfully processing an upcoming PO responsive to a PEI. As also described above with reference to the second aspect, when determining that the time gap or the minimum time required between the PEI and the PO increases, the UE may monitor one or more regular paging occasions regardless of a PEI, e.g., until the UE signaled a new value for the certain duration to the gNB. In accordance with other embodiments, in case of a change of the time gap, the UE may connect to the gNB 402, for example, by a random access channel, RACH, procedure and indicate the increase so that the gNB 402 may send the PEI with an appropriate timing ahead of the PO. For example, the UE 400 may determine changes in the channel quality or there may be a change in the DRX periodicity or DRX offset which requires a change in the minimum time gap between the PEI and the PO, and this may be signaled to the gNB accordingly. In accordance with other embodiments, the UE 400 may connect to the gNB 402 not immediately after determining a change of the minimum time gap, but in response to receiving a PEI. In accordance with yet other embodiments, in case of a change of the time gap, responsive to receiving a PEI, the UE may connect to the base station of the wireless communication network, e.g., using the RACH procedure, without monitoring the upcoming PO. Thus, the UE receives a PEI but since the timing has changed and the upcoming PO may not fulfill the timing criterion anymore, the UE may not be able to monitor that PO. Hence, the UE simply ignores that PO, e.g., in the sense that there may be paging or there may be not (normally the UE only wake-up if there is a paging) and wakes-up at the next opportunity, i.e. performs the RACH.

### Seventh Aspect of the Present Invention

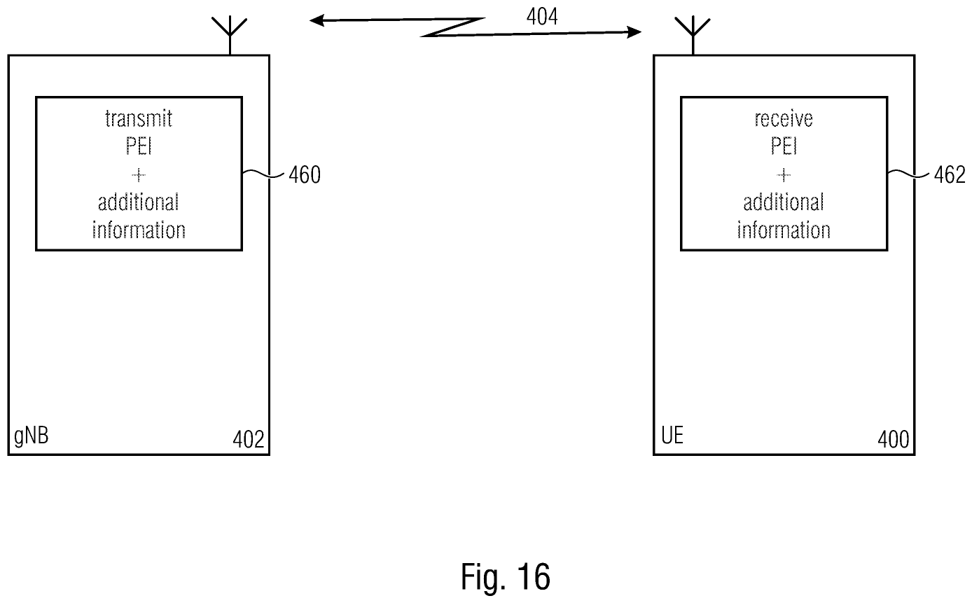

The seventh aspect of the present invention addressed the issue of improving the possibilities for further power savings by allowing a UE to reduce the minimum time gap between receiving a PEI and the upcoming PO. FIG. 16 illustrates a gNB 402 and a UE 400 in accordance with embodiments of the seventh aspect which allow reducing the length of the time gap between the PEI and the PO, for example even for UEs which require, as described above with reference to the sixth aspect of the present invention, two or more SSBs for the re-synchronization.

In accordance with embodiments, the gNB 402 provides the UE 400 over the radio channel 404 with the PEI at a time that may be less than the minimum time gap for the UE 400, however, as is indicated at 460, the gNB also transmits additional information which allow the UE 400 to reduce the minimum time gap, e.g., to synchronize faster with the network thereby allowing for reducing time gap between the PEI and the associated or upcoming PO. As is indicated at 462, responsive to receiving the PEI and the additional the UE 400 is capable to synchronize to the network faster than without the additional information.

For example, as mentioned above with reference to the sixth aspect, a UE may take up to three SSBs between the PEI and the PO to synchronize with the network, so that some UEs need to wake up a long time ahead of the actual paging message, thereby consuming power for this longer period of time. In accordance with embodiments of the seventh aspect, this wake up time is reduced, thereby allowing to save more energy, by sending from the network extra signals or additional information supporting or helping the UE to synchronize with the network during a shorter between the PEI and the PO. In accordance with embodiments of the present invention, additional SSBs may be provided that are transmitted more frequently than a regular SSB interval. For example, one or more additional SSBs associated with the UE may be transmitted in each antenna beam within the cell, like one SSB for each beam, or during beam sweeping only associated beams serving the UE to be paged are switched on and other beams are not used. When considering FIG. 14A, instead of transmitting only a single SSB 424₁ during the time gap 418₁, for a UE experiencing a medium or low SINR on the radio channel, during the time gap 418₁, two or more SSBs may be transmitted as an extra signaling, thereby providing also the medium or low SINR with the needed SSBs for quickly synchronizing with the network thereby allowing the monitoring of the PO after a time gap that is shorter than the regular time gap that depicted, for example, in FIG. 14B and FIG. 14C.

In accordance with other embodiments, a UE specific reference signal may be provide, e.g., a CSI-RS for a faster synchronization. A probability of a PEI miss-detection due to synchronization errors is reduced when u sing a UE specific reference signal. Consequently, the UE may be synchronized faster and wakes up to only monitor the associated paging occasion. Thus, while the wake-up time may be mainly determined by getting synchronization and decoding SIB and/or MIB, the additional reference signals helps the UE to synchronize faster.

In accordance with embodiments, gNB 402 may decide to transmit the PEI together with the additional information or the extra signals in case the PEI directed to a certain UE indicates that the UE is to expect receiving a paging message at the PO. Otherwise, in case the PEI indicates that there is no paging message to be expected, it is also not needed to provide the additional or extra SSBs. In accordance with yet other embodiments, the gNB 402 may determine whether the UE being paged actually needs additional synchronization signal blocks, for example, the gNB may determine the UE 400 to be in need of such additional information for speeding the synchronization procedure on the basis of the channel quality on the radio channel 404 which may be judged on the basis of the SINR or the RSRP. In accordance with other embodiments, the gNB may consider the UE category or may add the extra signals responsive to a signaling from the UE. For example, when the UE experiences problems in the processing of the signals either due to its processing capabilities or due to the channel quality, a signaling, responsive to the PEI may be performed requesting the additional or extra signals from the gNB 402. In case the gNB 402 is aware that the UE has only reduced capability, i.e. is a read cap UE, so that processing may require more information from the gNB side, on the basis of the UE category, the gNB may decide to transmit together with the PEI the additional information.

Thus, in accordance with embodiments of the seventh aspect, the required on time of the UE may be reduced below a minimum time gap between the PEI and the PO by providing the additional information supporting the synchronization of the UE to the network for monitoring the PO for paging messages thereby allowing for further power savings.

### General

Although the respective aspects and embodiments of the inventive approach have been described separately, it is noted that each of the aspects/embodiments may be implemented independent from the other, or some or all of the aspects/embodiments may be combined. Moreover, the subsequently described embodiments may be used for each of the aspects/embodiments described so far.

In accordance with embodiments, the UE may indicate, e.g., to the base station of the wireless communication network, if the UE supports PEIs. For example, the information that the UE supports PEI or not may be part of the UE capabilities signaled to the network.

In accordance with embodiments, the wireless communication system may include a terrestrial network, or a non-terrestrial network, or networks or segments of networks using as a receiver an airborne vehicle or a spaceborne vehicle, or a combination thereof.

In accordance with embodiments of the present invention, a user device comprises one or more of the following: a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and requiring input from a gateway node at periodic intervals, a mobile terminal, or a stationary terminal, or a cellular IoT-UE, or a vehicular UE, or a vehicular group leader (GL) UE, or a sidelink relay, or an IoT or narrowband IoT, NB-IoT, device, or wearable device, like a smartwatch, or a fitness tracker, or smart glasses, or a ground based vehicle, or an aerial vehicle, or a drone, or a moving base station, or road side unit (RSU), or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

In accordance with embodiments of the present invention, a network entity comprises one or more of the following: a macro cell base station, or a small cell base station, or a central unit of a base station, or a distributed unit of a base station, or a road side unit (RSU), or a remote radio head, or an AMF, or an MME, or an SMF, or a core network entity, or mobile edge computing (MEC) entity, or a network slice as in the NR or 5G core context, or any transmission/reception point, TRP, enabling an item or a device to communicate using the wireless communication network, the item or device being provided with network connectivity to communicate using the wireless communication network.

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

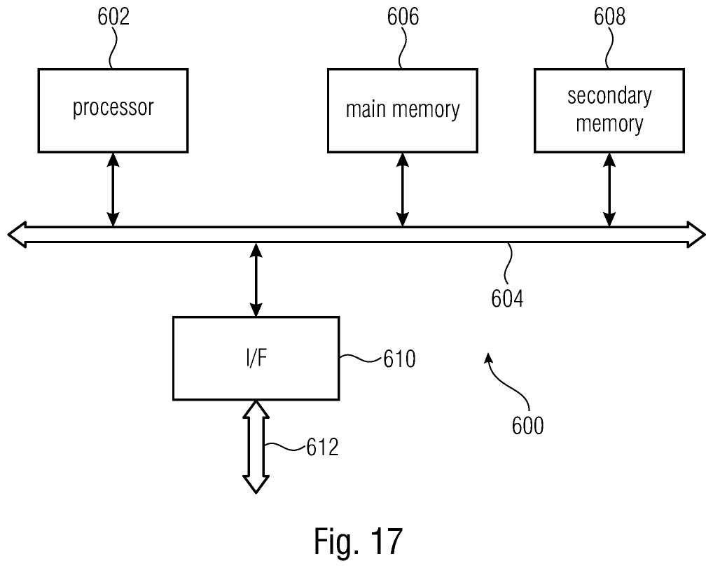

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 17 illustrates an example of a computer system 600. The units or modules as well as the steps of the methods performed by these units may execute on one or more computer systems 600. The computer system 600 includes one or more processors 602, like a special purpose or a general-purpose digital signal processor. The processor 602 is connected to a communication infrastructure 604, like a bus or a network. The computer system 600 includes a main memory 606, e.g., a random-access memory, RAM, and a secondary memory 608, e.g., a hard disk drive and/or a removable storage drive. The secondary memory 608 may allow computer programs or other instructions to be loaded into the computer system 600. The computer system 600 may further include a communications interface 610 to allow software and data to be transferred between computer system 600 and external devices. The communication may be in the from electronic, electromagnetic, optical, or other signals capable of being handled by a communications interface. The communication may use a wire or a cable, fiber optics, a phone line, a cellular phone link, an RF link and other communications channels 612.

The terms “computer program medium” and “computer readable medium” are used to generally refer to tangible storage media such as removable storage units or a hard disk installed in a hard disk drive. These computer program products are means for providing software to the computer system 600. The computer programs, also referred to as computer control logic, are stored in main memory 606 and/or secondary memory 608. Computer programs may also be received via the communications interface 610. The computer program, when executed, enables the computer system 600 to implement the present invention. In particular, the computer program, when executed, enables processor 602 to implement the processes of the present invention, such as any of the methods described herein. Accordingly, such a computer program may represent a controller of the computer system 600. Where the disclosure is implemented using software, the software may be stored in a computer program product and loaded into computer system 600 using a removable storage drive, an interface, like communications interface 610.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate or are capable of cooperating with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier. In other words, an embodiment of the inventive method is, therefore, a computer program having a program code for performing one of the methods described herein, when the computer program runs on a computer.

A further embodiment of the inventive methods is, therefore, a data carrier or a digital storage medium, or a computer-readable medium comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device, for example a field programmable gate array, may be used to perform some or all of the functionalities of the methods described herein. In some embodiments, a field programmable gate array may cooperate with a microprocessor in order to perform one of the methods described herein. Generally, the methods are performed by any hardware apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1-21. (canceled)

22. A user device, UE, for a wireless communication network,
wherein the UE is to monitor one or more paging occasions, POs, for a paging signal directed to the UE by a base station of the wireless communication network,
wherein the UE is to receive, ahead of an upcoming PO, a paging early indication, PEI, the PEI indicating whether the UE is to expect a paging signal in the upcoming PO,
wherein the UE is to operate in accordance with a first behavior or a second behavior, wherein in accordance with the first behavior the UE is to monitor one or more POs regardless if the PEI is received or not, and in accordance with the second behavior, the UE is to monitor one or more POs if the PEI indicates that the UE is to expect a paging signal in the upcoming PO, and
wherein, when operating in accordance with the second behavior, the UE is to switch to the first behavior responsive to a certain event.

23. The user device, UE, of claim 22, wherein the UE is to switch from the second behavior to the first behavior in case one or more of the following applies:
a power level of the cell supporting PEI monitoring drops below or increases above a configured or preconfigured threshold,
the UE receives a signaling that a configured or preconfigured threshold for a paging load is reached,
the UE moves into a geographical area in which it is mandated to select the first behavior,
expiry of a configured or preconfigured timer, like a Behv_selection_timer, during which no PEI or no PEI indicating the UE is to expect a paging message was received by the UE.

24. The user device, UE, of claim 23, wherein the UE is to receive a page load indication and/or the timer and/or information about the geographical area, and/or power level threshold from the wireless communication network, e.g., by the broadcast message, like the System Information Block 2, SIB2.

25. The user device, UE, of claim 22, wherein
in accordance with a first behavior, the PEI indicates that the UE is to monitor a PO in case a group or subgroup of UEs to which the UE belongs is paged during the PO, and the UE is not to monitor a PO in case the UE does not detect a PEI at some or all PEI occasions for the PO, or
in accordance with a second behavior, the PEI indicates whether or not the UE is to monitor a PO, and
the UE is to monitor a PO in case the UE does not detect a PEI at some or all PEI occasions for the PO.

26. The user device, UE, of claim 22, wherein the UE is to operate in a power saving mode or is a UE having capabilities reduced when compared to another UE.

27. The user device, UE, of claim 22, wherein the UE comprises one or more of the following: a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and requiring input from a gateway node at periodic intervals, a mobile terminal, or a stationary terminal, or a cellular IoT-UE, or a vehicular UE, or a vehicular group leader, GL, UE, or a sidelink relay, or an IoT or narrowband IoT, NB-IoT, device, or wearable device, like a smartwatch, or a fitness tracker, or smart glasses, or a ground based vehicle, or an aerial vehicle, or a drone, or a moving base station, or road side unit, RSU, or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

28. A wireless communication system, comprising one or more user devices, UEs,
wherein the UE is to monitor one or more paging occasions, POs, for a paging signal directed to the UE by a base station of the wireless communication network,
wherein the UE is to receive, ahead of an upcoming PO, a paging early indication, PEI, the PEI indicating whether the UE is to expect a paging signal in the upcoming PO,
wherein the UE is to operate in accordance with a first behavior or a second behavior, wherein in accordance with the first behavior the UE is to monitor one or more POs regardless if the PEI is received or not, and in accordance with the second behavior, the UE is to monitor one or more POs if the PEI indicates that the UE is to expect a paging signal in the upcoming PO, and
wherein, when operating in accordance with the second behavior, the UE is to switch to the first behavior responsive to a certain event.

29. The wireless communication system of claim 28, further comprising one or more RANs and a CN, wherein a RAN entity comprises one or more of the following: a macro cell base station, or a small cell base station, or a central unit of a base station, or a distributed unit of a base station, or a road side unit, RSU, or a UE, or a group leader, GL, or a relay or a remote radio head, or an AMF, or an MME, or an SMF, or a core network entity, or mobile edge computing, MEC, entity, or a network slice as in the NR or 5G core context, or any transmission/reception point, TRP, enabling an item or a device to communicate using the wireless communication network, the item or device being provided with network connectivity to communicate using the wireless communication network.

30-45. (canceled)

46. A method for operating a wireless communication network, the method comprising:
monitoring, by a user device, one or more paging occasions, POs, for a paging signal directed to the UE by a base station of the wireless communication network,
receiving, by the UE, ahead of an upcoming PO, a paging early indication, PEI, the PEI indicating whether the UE is to expect a paging signal in the upcoming PO, wherein the UE is to operate in accordance with a first behavior or a second behavior, wherein in accordance with the first behavior the UE is to monitor one or more POs regardless if the PEI is received or not, and in accordance with the second behavior, the UE is to monitor one or more POs if the PEI indicates that the UE is to expect a paging signal in the upcoming PO, and
when operating in accordance with the second behavior, switching to the first behavior responsive to a certain event.

47-48. (canceled)

49. A non-transitory digital storage medium having a computer program stored thereon to perform, when said computer program is run by a computer, a method for operating a wireless communication network, the method comprising:
monitoring, by a user device, one or more paging occasions, POs, for a paging signal directed to the UE by a base station of the wireless communication network,
receiving, by the UE, ahead of an upcoming PO, a paging early indication, PEI, the PEI indicating whether the UE is to expect a paging signal in the upcoming PO, wherein the UE is to operate in accordance with a first behavior or a second behavior, wherein in accordance with the first behavior the UE is to monitor one or more POs regardless if the PEI is received or not, and in accordance with the second behavior, the UE is to monitor one or more POs if the PEI indicates that the UE is to expect a paging signal in the upcoming PO, and
when operating in accordance with the second behavior, switching to the first behavior responsive to a certain event.

50. A base station for a wireless communication network, the wireless communication network providing one or more paging occasions, POs, to be monitored by a user device, UE, of the wireless communication network,
wherein the base station is to direct to the UE a paging signal and, ahead of an upcoming PO, a paging early indication, PEI, the PEI indicating whether the UE is to expect a paging signal in the upcoming PO,
wherein the UE is to operate in accordance with a first behavior or a second behavior, wherein in accordance with the first behavior the UE is to monitor one or more POs regardless if the PEI is received or not, and in accordance with the second behavior, the UE is to monitor one or more POs if the PEI indicates that the UE is to expect a paging signal in the upcoming PO, and
wherein, when operating in accordance with the second behavior, the UE is to switch to the first behavior responsive to a certain event.
